(19) United States
(12) Patent Application Publication
(10) Pub. No.: US 2008/0297661 A1
(43) Pub. Date: Dec. 4, 2008

(54) SIGNAL DISTRIBUTION DEVICE, RECEIVER DEVICE, AND APPARATUS INCLUDING RECEIVER DEVICE

(76) Inventor: Masanori KITAGUCHI, Osaka (JP)

Correspondence Address: BIRCH STEWART KOLASCH & BIRCH, PO BOX 747, FALLS CHURCH, VA, 22040-0747, US

(21) Appl. No.: 12/107,464

(22) Filed: Apr. 22, 2008

(30) Foreign Application Priority Data
Apr. 24, 2007 (JP) 2007-114772

(51) Int. Cl. H04N 5/268; H04N 5/50

(52) U.S. Cl. 348/705; 348/731; 348/E05.057; 348/E05.097

(57) ABSTRACT

A signal distribution device that is provided in a tuner of the present invention includes a plurality of demodulators, a voltage comparator, a switch, a broadband amplifier, and a balun. This allows the signal distribution device of the present invention to realize a signal distribution device capable of controlling a level of a signal that a distributor outputs.

This Nonprovisional application claims priority under U.S.C. § 119(a) on Patent Application No. 114772/2007 filed in Japan on Apr. 24, 2007, the entire contents of which are hereby incorporated by reference.

### FIELD OF THE INVENTION

The present invention relates to a tuner device for receiving a terrestrial digital broadcast or terrestrial analog broadcast, and particularly to a tuner device including a signal distribution device that outputs to distribute an RF (Radio Frequency) signal into a plurality of circuits.

### BACKGROUND OF THE INVENTION

Recently, apparatuses such as a television receiver and a DVD (Digital Versatile Disc) recorder have been increased in size, and the apparatuses each including a built-in HDD (Hard Disc Drive) have been increasing.

The increase of such apparatuses has been increasing apparatuses each of which has a function to concurrently receive a plurality of broadcasts. An example of such apparatuses is a multi-screen display apparatus (an apparatus capable of concurrently showing a plurality of broadcasts or broadcast and video image of a DVD that is connected to a video image input terminal) and a dual video signal simultaneous recording apparatus (an apparatus in which normal HDD recording or recording by back recording may be selected at recording reservation of a program to be recorded and, when recording reservations overlap, both programs can be recorded by switching one to recording by back recording).

On the apparatus capable of concurrently receiving a plurality of broadcasts, a set substrate including a plurality of tuners is mounted. The set substrate distributes to each tuner an RF signal that is inputted into the set substrate, with the use of a signal distributor called a balun. However, the RF signal that is inputted into the balun is outputted to each tuner in a state in which a level of the RF signal decreases by approximately 4 dB due to distribution loss. Accordingly, a level of an RF signal that is inputted into each tuner decreases. This deteriorates a noise factor of a signal that is inputted from each tuner into each of a plurality of demodulators for demodulating the signal. As a result, sensitivity of each tuner deteriorates.

As a technique to solve this problem, for example, Patent Document 1 (Japanese Unexamined Patent Publication No. 8929/2003 (Tokukai 2003-8929) published on Jan. 10, 2003) discloses that an amplifier is provided in a proceeding stage of a balun so as to compensate the distribution loss by amplifying the signal that is inputted via an input terminal and prevent sensitivity deterioration of the device provided in a subsequent stage of the balun.

However, according to the technique as disclosed in Patent Document 1, when the level of the inputted RF signal is large, distortion occurs in the amplifier. That is, in an arrangement in which the amplifier is provided in the proceeding stage of the balun and all the RF signals are amplified, a BER (Bit Error Rate) of a signal that is outputted from this amplifier deteriorates in case where the level of the RF signal that is inputted into the amplifier is too large. This deteriorates a noise factor of a signal that is inputted into each of the plurality of demodulators. As a result, the sensitivity of the tuner deteriorates.

Patent Document 2 (Japanese Unexamined Patent Publication No. 92010/1990 (Tokukaihei 2-92010) published on Mar. 30, 1990) discloses a technique to solve the problem. In the technique as disclosed in Patent Document 2, a series circuit composed of a variable attenuator and an amplifier is provided in a proceeding stage of the balun.

In other words, an RF distribution circuit disclosed in Patent Document 2 includes a series circuit composed of the variable attenuator and the amplifier that are provided in a proceeding stage of the balun. An attenuation amount of the variable attenuator is adjusted according to a level of the RF signal that is inputted into the RF distribution circuit. This allows the signal that is inputted into the amplifier to be kept at a constant level. Further, regardless of the level of the RF signal that is inputted into the RF distribution circuit, the amplifier amplifies the RF signal by a gain that compensates the distribution loss that is caused by the balun.

In the arrangement according to the technique of Patent Document 2, the variable attenuator adjusts the RF signal to be at a constant level, and amplifies the adjusted signal by a constant gain. Accordingly, the RF signal is kept at a constant level even when distribution loss occurs in distribution of the signal with the use of the balun.

However, in case where the technique as disclosed in the Patent Document 2 is applied to the set substrate, it becomes difficult to control the level of the RF signal that is outputted from the distributor. Particularly in this case, it becomes difficult to control the level of the RF signal that is outputted from the distributor, according to a reception state of each tuner.

That is, when the series circuit composed of the variable attenuator and the amplifier is provided in the proceeding stage of the balun as in the technique disclosed in the Patent Document 2, the RF signal that is inputted into the balun can be outputted to the tuner at a constant level. However, various processes such as frequency band limitation of the RF signal and amplification of the RF signal are executed during the time from input of the RF signal into the tuner, which RF signal is outputted from the distributor, to input of the RF signal into the demodulator. The processes are executed in each tuner in case where a plurality of tuners are provided. Accordingly, even if the RF signal that is outputted from the balun is kept at a constant level, the signal that is inputted into the demodulator may not be at a constant level. This results in that a level of the signal to be inputted into the demodulator may be different in each tuner.

Namely, the balun may not be able to reliably input into the demodulator an RF signal at a level desirable to the demodulator.

Further, in case where a characteristic of the tuner changes, for example, due to a long-time use, it becomes difficult to input an RF signal at a desirable level to the tuner whose characteristic has changed. Therefore, reliability of the tuner becomes low.

In addition, a technique as disclosed in Patent Document 1 or 2 is applied to the set substrate or neither the technique as disclosed in Patent Document 1 nor the technique as disclosed in Patent Document 2 is applied to the set substrate, a plurality of coaxial cables become necessary for wiring in the set substrate. This leads to cost increase. That is, in this case, necessary coaxial cables that should be prepared become a coaxial cable to connect an input terminal of the set substrate with an input terminal of the balun and coaxial cables, whose number is equal to the number of tuners, each for connecting an output terminal of the balun with an input terminal of each tuner.

### SUMMARY OF THE INVENTION

The present invention is attained in view of the problems mentioned above. An object of the present invention is to realize a signal distribution device capable of controlling a level of a signal that a distributor outputs.

Another object of the present invention is to realize a receiver device capable of supplying a signal at a desired level to a receiver circuit in accordance with a change in a level of a signal inputted into the demodulator.

Still another object of the present invention is to realize a receiver device capable of reducing material cost and man-hour by suppressing cost increase that results from use of a plurality of coaxial cables.

In order to solve the problem mentioned above, a signal distribution device of the present invention including a distributor that outputs to distribute a signal inputted into the distributor into a plurality of circuits, the signal distribution device includes: an amplifier amplifying a level of a signal to be inputted into the distributor; a switching circuit switching between a first state and a second state, the level of the signal inputted into the distributor in the first state being a different value from a value of the level of the signal inputted into the distributor in the second state; and a voltage comparison control circuit controlling switching by the switching circuit according to a voltage value of a control voltage inputted into the voltage comparison control circuit.

According to the arrangement, the signal distribution device of the present invention includes an amplifier, a switching circuit, and a voltage comparison control circuit. The amplifier amplifies a signal inputted into the amplifier and outputs the amplified signal to the distributor. Moreover, the switching circuit switches between the first state and the second state. Further, the voltage comparison control circuit controls the switching circuit according to the control voltage inputted into the voltage comparison control circuit.

In case where the signal inputted into the distributor is kept at a constant level as in a conventional arrangement, the level of the signal may vary during application of various signal processes in the circuit into which the signal that is outputted from the distributor is inputted. The variation in the level of the signal makes it impossible to supply a signal having a level desirable to the circuit.

On the other hand, in the signal distribution device of the present invention, the voltage comparison control circuit controls the switching circuit that varies the level of the signal, thereby allowing the level of the signal inputted into the distributor to be varied. This makes it possible to reliably supply the signal at the level desirable to the circuit by setting the control voltage to an appropriate value, even in case where the variation in the level of the signal occurs.

Accordingly, it becomes possible to control the level of the signal that the distributor outputs.

In order to solve the problem mentioned above, a signal distribution device of the present invention including a distributor that outputs to distribute a signal inputted into the distributor into a plurality of circuits, the signal distribution device includes: an amplifier amplifying a level of a signal to be inputted into the distributor; a variable attenuator attenuating a level of a signal to be inputted into the amplifier and having a variable attenuation amount; and a voltage comparison control circuit controlling the attenuation amount of the variable attenuator according to a voltage value of a control voltage inputted into the voltage comparison control circuit, the voltage value of the control voltage inputted into the voltage comparison control circuit being a register expressing a binary ten-digit value as a value in a decimal system which binary ten-digit value is determined according to a level of the voltage value, and the voltage comparison control circuit controlling variation in the attenuation amount of the attenuator in the switching circuit based on a comparison result of comparing the register of the voltage value of the control voltage inputted into the voltage comparison control circuit and a predetermined threshold value of the register.

According to the arrangement, the signal distribution device of the present invention includes an amplifier, a variable attenuator, and a voltage comparison control circuit. The amplifier amplifies the signal inputted into the amplifier and outputs the signal to the distributor. The variable attenuate, whose attenuation amount is variable, attenuates the signal inputted into the variable attenuator and outputs the signal to the amplifier. Further, the voltage comparison control circuit controls the attenuation amount of the variable attenuator according to the control voltage inputted into the voltage comparison control circuit. The voltage value of the control voltage inputted into the voltage comparison control circuit is a register. The voltage comparison control circuit controls variation in the attenuation amount of the variable attenuator in the switching circuit, based on a comparison result of comparing the register of the voltage value of the control voltage inputted into the voltage comparison control circuit and a predetermined register. In the present application, the “register” is a value that expresses, as a value in a decimal system, a binary ten-digit value determined according to the level of the voltage.

In case where the signal inputted into the distributor is kept at a constant level as in a conventional arrangement, the level of the signal may vary during application of various signal processes in the circuit into which the signal that is outputted from the distributor is inputted.

On the other hand, in the signal distribution device of the present invention, the voltage comparison control circuit controls the switching circuit that varies the level of the signal, based on a comparison result of comparing a voltage value of a control voltage inputted as a register and a predetermined threshold value of the register of the voltage value. This allows varying the level of the signal to be inputted into the distributor.

Accordingly, the level of the signal that is outputted from the distributor can be controlled. Moreover, because the control is performed by appropriately varying the attenuation amount of the variable attenuator, the control can be performed more precisely.

In order to solve the problem mentioned above, a signal distribution device of the present invention including a distributor that outputs to distribute a signal inputted into the distributor into a plurality of circuits, the signal distribution device includes: an amplifier amplifying a level of a signal to be inputted into the distributor; a variable attenuator attenuating a level of a signal to be inputted into the amplifier and having a variable attenuation amount; an error transmission circuit transmitting an error flag in case where an error occurs; and an error flag comparison control circuit, into which the error flag outputted from the error transmission circuit is inputted, controlling the attenuation amount of the variable attenuator according to a number of times for which the error flag is inputted.

According to the arrangement, the signal distribution device of the present invention includes an amplifier, a variable attenuator, an error transmission circuit, and an error flag comparison control circuit. The amplifier amplifies the signal inputted into the amplifier and outputs the signal to the distributor. The variable attenuator whose attenuation amount is variable attenuates the signal inputted into the variable attenuator and outputs the signal to the amplifier. Moreover, the error flag comparison control circuit receives an error flag outputted from the error transmission circuit and controls the attenuation amount of the variable attenuator according to the number of times for which the error flag is inputted.

In case where the signal inputted into the distributor is kept at a constant level as in a conventional arrangement, the level of the signal may vary during application of various signal processes in the circuit into which the signal that is outputted from the distributor is inputted.

On the other hand, in the signal distribution device of the present invention, the error flag comparison control circuit controls the level of the signal according to the number of times for which the error flag is inputted, thereby varying the level of the signal to be inputted into the distributor.

Accordingly, the level of the signal outputted from the distributor can be controlled. Moreover, because the control is performed by appropriately varying a gain of the variable amplifier, the level of the signal can be more precisely controlled.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a circuit diagram illustrating one configuration example of a tuner, according to one embodiment of the present invention.

FIG. 2(a) is a graph illustrating a relationship between a level of an RF signal that is inputted into the tuner and AGC voltages of a demodulator.

FIG. 2(b) is a graph illustrating a relationship between a level of an RF signal that is inputted into the tuner and a gain of an entire tuner.

FIG. 2(c) is a graph illustrating a relationship between a level of an RF signal that is inputted into the tuner and a level of a signal that is inputted into the demodulator.

FIG. 2(d) is a graph illustrating a relationship between a level of an RF signal that is inputted into the tuner and a BER of a signal that is inputted into the demodulator.

FIG. 3 is a circuit diagram illustrating one configuration example of a tuner, according to another embodiment of the present invention.

FIG. 4 is a circuit diagram illustrating one configuration example of a tuner, according to another embodiment of the present invention.

FIG. 5 is a diagram illustrating one example of a configuration including a broadband amplifier capable of performing sequential gain switching, according to another embodiment of the present invention.

FIG. 6(a) is a diagram illustrating a configuration of a current feedback bias transistor amplifying circuit including a feedback circuit that provides feedback from a collector of a transistor to a base thereof.

FIG. 6(b) is a diagram illustrating one configuration example of a broadband amplifier capable of performing sequential gain switching.

FIG. 6(c) is a diagram illustrating one configuration example of a broadband amplifier capable of performing sequential gain switching.

FIG. 6(d) is a diagram illustrating one configuration example of a broadband amplifier capable of performing sequential Rain switching.

FIG. 6(e) is a diagram illustrating one configuration example of a broadband amplifier capable of performing sequential gain switching.

FIG. 6(f) is a diagram illustrating one configuration example of a broadband amplifier capable of performing sequential gain switching.

FIG. 7 is a circuit diagram illustrating one configuration example of a tuner, according to another embodiment of the present invention.

FIG. 8(a) is a diagram illustrating one configuration example of an attenuator that is provided in a tuner of the present invention.

FIG. 8(b) is a diagram illustrating one configuration example of a variable attenuator that is provided in a tuner of the present invention.

FIG. 9 is a circuit diagram illustrating one configuration example of a tuner, according to another embodiment of the present invention.

FIG. 10 is a block diagram schematically illustrating a configuration of a set substrate including a plurality of tuners, which set substrate is mounted on an apparatus capable of concurrently receiving a plurality of terrestrial digital broadcasts.

### DESCRIPTION OF THE EMBODIMENTS

The following explains embodiments of the present invention. For convenience of an explanation, members given the same reference numerals respectively have identical functions and the explanations thereof are omitted.

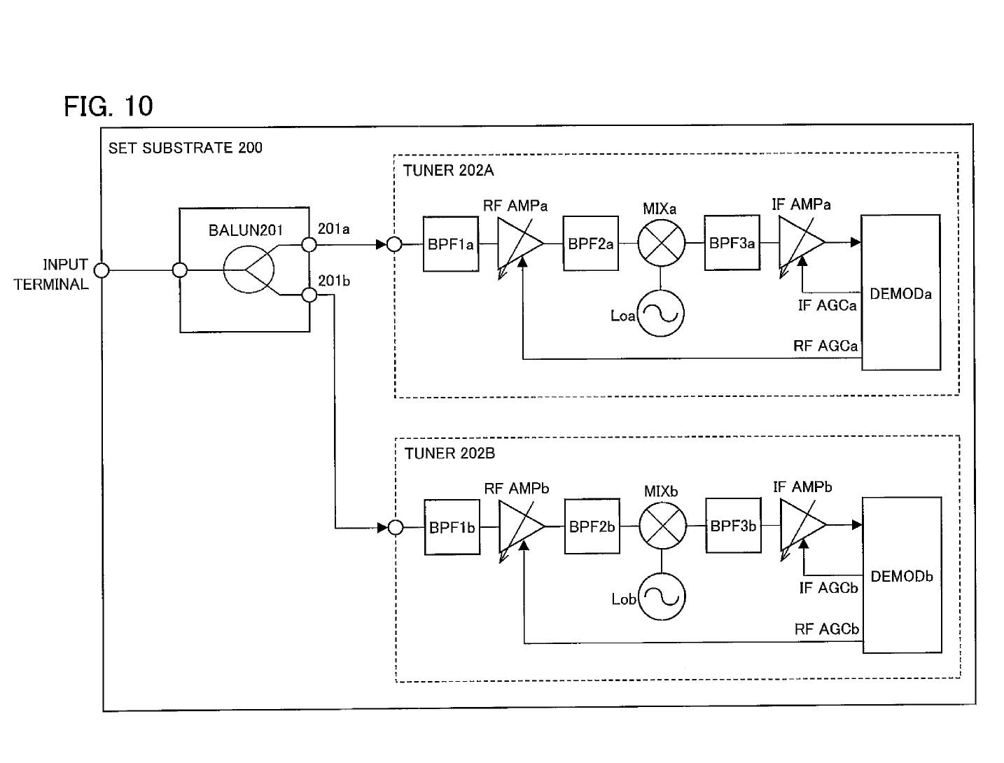

First, with reference to FIG. 10, an apparatus capable of concurrently receiving a plurality of broadcasts is explained.

FIG. 10 is a block diagram schematically illustrating a configuration of a set substrate including a plurality of tuners, which set substrate is mounted on an apparatus capable of concurrently receiving a plurality of terrestrial digital broadcasts.

A set substrate 200 includes a balun 201 as a distributor and tuners 202A and 202B.

An RF signal that is inputted via an input terminal of the set substrate 200 is inputted into the balun 201.

The balun 201 includes two output terminals 201a and 201b that corresponds to one input terminal. The balun 201 outputs the inputted RF signal from the one output terminal 201a to the tuner 202A. Moreover, the balun 201 outputs the RF signal from the other output terminal 201b to the tuner 202B.

The RF signal that is inputted into the tuner 202A is outputted to a high frequency amplifier RF AMPa after an RF signal only in a desired frequency band is extracted by a bandpass filter BPF1a.

The high frequency amplifier RF AMPa amplifies the signal that is inputted from the bandpass filter BPF1a and outputs the amplified signal to a bandpass filter BPF2a.

The bandpass filter BPF 2a further limits a frequency band of the signal that is inputted from the high frequency amplifier RF AMPa, and outputs the signal to a mixer circuit MIXa.

The signal that is outputted from the bandpass filter BPF2a is inputted into the mixer circuit MIXa. The signal that is inputted into the mixer circuit MIXa is converted in terms of frequency by mixing with a local oscillating component that is generated in a local oscillating circuit Loa. Thus converted signal is outputted to a bandpass filter BPF 3a as an IF signal (Intermediate Frequency signal).

The bandpass filter BPF3a limits a frequency band of the TF signal that is inputted from the mixer circuit MIXa, and extracts an IF signal only in a desired frequency hand. Then, the bandpass filter BPF3a outputs the extracted IF signal to an intermediate frequency amplifier IF AMPa.

The intermediate frequency amplifier IF aMPa amplifies the signal inputted from the bandpass filter BPF3a and outputs the amplified signal to a demodulator DEMODa.

The demodulator DEMODa controls, according to a level of the signal that is inputted into the demodulator DEMODa, a gain of the high frequency amplifier RF AMPa by varying an AGC (Automatic Gain Control) voltage RF AGCa and a gain of the intermediate frequency amplifier IF AMPa by varying an AGC voltage IF AGCa.

That is, in case where a level of a signal that is inputted into the demodulator DEMODa is smaller than a desired level, the demodulator DEMODa performs either one or both of an operation to raise a gain of the high frequency amplifier RF AMPa by increasing the AGC voltage RF AGCa and an operation to raise a gain of the intermediate frequency amplifier IF AMPa by increasing the AGC voltage IF AGCa. Moreover, in case where the signal level inputted into the demodulator DEMODa is larger than a desired level, the demodulator DEMODa performs either one or both of an operation to lower a gain of the high frequency amplifier RF AMPa by decreasing the AGC voltage RF AGCa and an operation to lower a gain of the intermediate frequency amplifier IF AMPa by decreasing an AGC voltage IF AGCa.

In this way, the demodulator DEMODa appropriately varies voltage values of the AGC voltages RF AGCa and IF AGCa so that gains of the high frequency amplifier RF AMPa and the intermediate frequency amplifier IF AMPa become optimum values, thereby obtaining a constant level of a signal that is inputted into the demodulator DEMODa.

The tuner 202B performs an operation that is the same as the operation of the tuner 202A.

Namely, the bandpass filter BPF1b extracts an RF signal only in a desired frequency band from the RF signal that is inputted into the tuner 202B. Then, a high frequency amplifier RF AMPb amplifies the extracted RF signal. A bandpass filter BPF2b further limits the frequency band of the RF signal and outputs the RF signal to a mixer circuit MIXb. The signal that is inputted into the mixer circuit MIXb is converted in terms of frequency by mixing with a local oscillating component that is generated in a local oscillating circuit Lob, and outputted as an IF signal. A bandpass filter BPF3b extracts an IF signal only in a desired frequency band from the IF signal that is outputted from the mixer circuit MIXb. An intermediate frequency amplifier IF AMPb amplifies the extracted IF signal and outputs the amplified IF signal to a demodulator DEMODb. The demodulator DEMODb controls, according to a level of the signal inputted into the demodulator DEMODb, a gain of the frequency amplifier RF AMPb by varying the AGC voltage RF AGCb and a gain of the intermediate frequency amplifier IF AMPb by varying the AGC voltage IF AGCb. That is, the demodulator DEMODb appropriately varies voltage values of the AGC voltage RF AGCb and IF AGCb so that gains of the high frequency amplifier RF AMPb and the intermediate frequency amplifier IF AMPb become optimum, thereby obtaining a constant level of a signal that is inputted into the demodulator DEMODb.

As mentioned above, in the set substrate 200 as shown in FIG. 10, the RF signal is distributed into the tuners 202A and 202B with the use of the balun 201. However, the RF signal that is inputted into the balun 201 is outputted to the tuners 202A and 202B in a state in which a level of the RF signal decreases by approximately 4 dB due to distribution loss. Accordingly, the level of the RF signal that is inputted into the tuners 202A and 202B decreases. This deteriorates noise factors of signals that are inputted into the demodulators DEMODa and DEMODb, respectively. As a result, sensitivity of the tuners 202A and 202B deteriorates.

Further, in case where a technique disclosed in Patent Document 2 as mentioned above is applied to the set substrate 200 as illustrated in FIG. 10, it is difficult to control the level of the RF signal that is outputted from the distributor. Particularly in this case, it is difficult to control, according to a reception state of each of the plurality of tuners, the level of the RF signal that is outputted from the distributor.

That is, in case where a parallel circuit composed of a variable attenuator and an amplifier is provided in a preceding stage of the balun as shown in FIG. 10 by applying the technique as disclosed in Patent Document 2, the RF signal that is to be inputted into the balun 201 can be adjusted to a constant level and outputted to the tuners.

However, various processes such as frequency band limitation of the RF signal by the bandpass filter BPFTa and amplification of the RF signal by the high frequency amplifier RF AMPa are executed during the time from input of the RF signal into the tuner 202A, which RF signal is outputted from the balun 201 as a distributor, to input of the RF signal into the demodulator DEMODa. In the tuner 202B, as in the tuner 202A, various processes such as frequency band limitation of the RF signal by the bandpass filter BPF1b and amplification of the RF signal by the high frequency amplifier RF AMPb are executed during the time from input of the RF signal into the tuner 202B to input of the RF signal into the demodulator DEMODb.

Accordingly, even if the RF signal is outputted at a constant level from the balun 201, the signal that is inputted into the demodulators DEMODa and DEMODb may not be at a constant level. This results in that the level of the signal that is inputted into the demodulator DEMODa of the tuner 202A may not be the same as the level of the signal that is inputted into the demodulator DEMODb of the tuner 202B.

Namely, the balun 201 may not be able to reliably input an RF signal at a level desirable to the demodulators DEMODa and DEMODb into the demodulators DEMODa and DEMODb.

Further, in case where a characteristic of the tuner 202A and/or the tuner 202B changes, for example, due to a long-time use, it becomes impossible to input the RF signal at a desirable level to the tuner 202A and/or the tuner 202B whose characteristic has changed. Therefore, reliability of the tuner 202A and/or the tuner 202B becomes low.

In addition, in case where a technique disclosed in Patent Document 1 or 2 is applied to the set substrate 200 as illustrated in FIG. 10 or the set substrate 200 as illustrated in FIG. 10 is used as it is, a plurality of coaxial cables become necessary. This leads to cost increase.

That is, in the case mentioned above, necessary coaxial cables that should be prepared are a coaxial cable to connect the input terminal of the set substrate 200 with the input terminal of the balun 201, a coaxial cable to connect one output terminal 201a of the balun 201 with an input terminal of the tuner 202A, and a coaxial cable to connect the other output terminal 201b of the balun 201 with an input terminal of the tuner 202B.

The following explains a signal distributor device capable of controlling a level of a signal that the distributor outputs and a receiver device including the signal distributor device.

### Embodiment 1

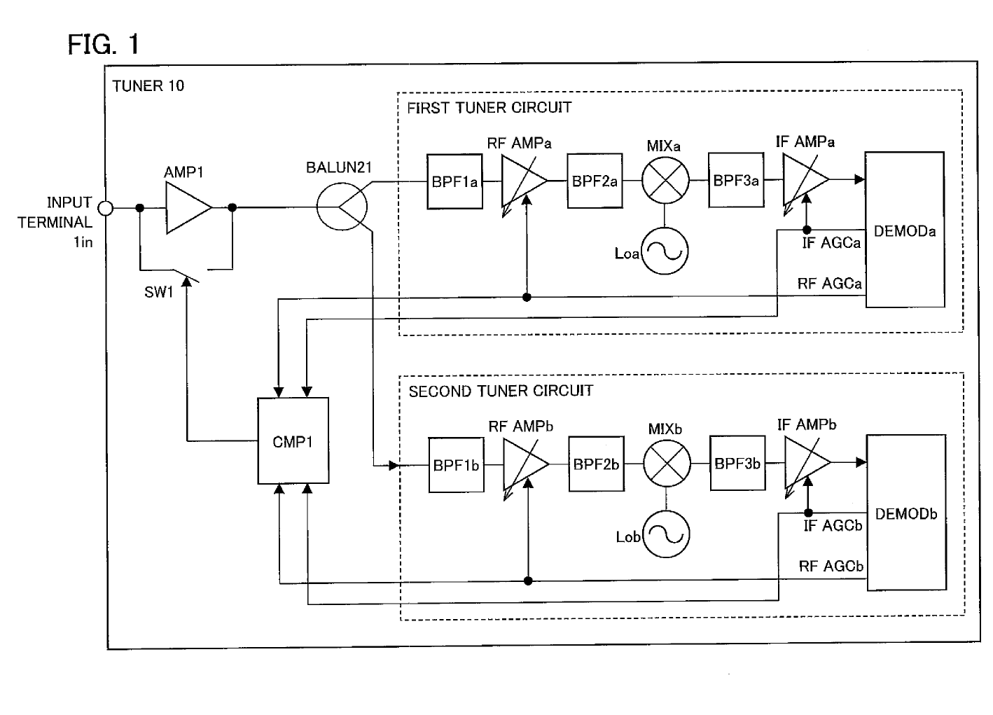

FIG. 1 is a circuit block diagram of a receiver device of the present invention.

A tuner (receiver device) 10 as illustrated in FIG. 1 includes a plurality of tuner circuits (a plurality of circuits, a plurality of receiver circuits). The tuner 10 includes, as a first tuner circuit, a bandpass filter BPF1a, a high frequency amplifier RF AMPa, a bandpass filter BPF2a, a mixer circuit MIXa that is connected to a local oscillating circuit Loa, a bandpass filter BPF3a, an intermediate frequency amplifier IF AMPa, and a demodulator DEMODa. Moreover, the tuner 10 as illustrated in FIG. 1 includes, as a second tuner circuit, a bandpass filter BPF1b, a high frequency amplifier RF AMPb, a bandpass filter RPF2b, a mixer circuit MIXb that is connected to a local oscillating circuit Lob, a bandpass filter BPF3b, an intermediate frequency amplifier IF AMPb, and a demodulator DEMODb. Further, the tuner 10 as illustrated in FIG. 1 includes a signal distributor device including a broadband amplifier (amplifier) AMP1, a switch (switching means) SW1, a balun (distributor) 21, and a voltage comparator (voltage comparison control means) CMP1, and an input terminal 1in.

The input terminal 1in is an input terminal of the tuner 10 and connected to a receiving section (not shown) of the receiver device that receives an RF signal inputted into an apparatus (hereinafter referred to as a “receiver”, not shown) capable of concurrently receiving a plurality of terrestrial digital broadcasts every time a receive channel (frequency band) is selected. The input terminal 1in functions as an input terminal of the receiver. When the receiving section of the receiver receives an RF signal, this RF signal is inputted into the input terminal 1in.

An example of the “receiver” here, that is, “an apparatus capable of concurrently receiving a plurality of terrestrial digital broadcasts” is a multi-screen display apparatus (an apparatus capable of concurrently showing a plurality of broadcasts or broadcast and video image of a DVD that is connected to a video image input terminal) and a dual video signal simultaneous recording apparatus (an apparatus in which normal HDD recording or recording by back recording (recording by using a region different from a region used in the normal HDD recording) may be selected at recording reservation of a program to be recorded and, when recording reservations of programs overlap, both programs can be recorded by switching one to recording by back recording). The “receiver” is not limited to this.

A parallel circuit, which is composed of the broadcast amplifier AMP1 and the switch SW1, and a balun 21 are connected to the input terminal 1in in series.

The broadband amplifier AMP1 amplifies the RF signal that is inputted via the input terminal 1in. The broadband amplifier AMP1 may be any broadband amplifier as long as the broadband amplifier is capable of amplifying the signal that is inputted into the broadband amplifier itself. Any broadband amplifier in a known arrangement may be used as such a broadband amplifier. Moreover, a gain of the broadband amplifier AMP1 is preferably set, for example, in a range of 5 to 15 dB. However, the gain is not limited to this. Namely, the gain of the broadband amplifier AMP1 may be set as appropriate according to a characteristic of the tuner, or the like.

The switch SW1 is a switch for switching between ON state and OFF state, according to a control signal from the voltage comparator CMP1 explained later. The switch SW1 may be any switch as long as the switch can perform on/off switching according to a signal transmitted from the voltage comparator CMP1. Any switch in a known arrangement may be used as the switch SW1 as long as the switch has the performance as mentioned above.

The balun 21 outputs to distribute the RF signal into a plurality of lines which RF signal is inputted into the balun 21. That is, the balun 21 outputs the RF signal that is inputted into the balun 21 to the bandpass filter BPF1b as well as the bandpass filter BPF1a.

Any balun in a known arrangement may be used as the balun 21 as long as the balun is arranged to be capable of outputting to distribute the inputted signal into a plurality of circuits. Obviously, the balun 21 may be the same as a balun 201 used in the set substrate 200 as illustrated in FIG. 10. In the present embodiment and the embodiment explained later, the balun 21 outputs to distribute a signal into two circuits (bandpass filters BPF1a and BPF1b) which signal is inputted into the balun 21. However, the balun 21 may output to distribute the signal into not less than three circuits which signal is inputted into the balun 21. That is, the balun 21 is a balun capable of outputting to distribute the inputted signal into a plurality of lines. Any balun r in a known arrangement may be used as such a balun.

The bandpass filter BPF1a extracts a desired signal component from a signal that is inputted into the bandpass filter BPF1a, and outputs the extracted signal component to the high frequency amplifier RF AMPa. The band pass filter BPF1b extracts a desired signal component from a signal that is inputted into the bandpass filter BPF1b, and outputs the extracted signal component to the high frequency amplifier RF AMPb.

The high frequency amplifier RF AMPa amplifies a signal that is inputted from the bandpass filter BPF1a, and outputs the amplified signal to the bandpass filter BPF2a. The high frequency amplifier RF AMPb amplifies a signal that is inputted from the bandpass filter BPF1b, and outputs the amplified signal to the bandpass filter BPF2b.

The bandpass filter BPF2a further limits a frequency band of the signal that is inputted from the high frequency amplifier RF AMPa, and outputs the signal to the mixer circuit MIXa. The bandpass filter BPF2b further limits a frequency band of a signal that is inputted from the high frequency amplifier RF AMPb, and outputs the signal to the mixer circuit MIXb.

The mixer circuit MIXa includes the local oscillating circuit Loa. The mixer circuit MIXa mixes the signal that is inputted from the bandpass filter BPF2a with a local oscillating component that is generated in the local oscillating circuit Loa, so as to convert the signal in terms of frequency. Then, the mixer circuit MIXa outputs the converted signal to the bandpass filter BPF3a as an IF signal. The mixer circuit MIXb includes the local oscillating circuit Lob. The mixer circuit MIXb mixes the signal that is inputted from the bandpass filter BPF2b with a local oscillating component that is generated in the local oscillating circuit Lob, so as to convert the signal in terms of frequency. Then, the mixer circuit MIXb outputs the converted signal to the bandpass filter BPF3b as an IF signal.

The bandpass filter BPF3a limits a frequency band of the IF signal that is inputted from the mixer circuit MIXa, and extracts an IF signal only in a desired frequency band. Then, the bandpass filter BPF3a outputs the extracted IF signal to the intermediate frequency amplifier IF AMPa. The bandpass filter BPF3b limits a frequency band of the IF signal that is inputted from the mixer circuit MIXb, and extracts an IF signal only in a desired frequency band. Then, the bandpass filter BPF3b outputs the extracted IF signal to the intermediate frequency amplifier IF AMPb.

The intermediate amplifier IF AMPa amplifies the signal that is inputted from the bandpass filter BPF3a and outputs the amplified signal to the demodulator DEMODa. The intermediate amplifier IF AMPb amplifies the signal inputted from the bandpass filter BPF3b and outputs the amplified signal to the demodulator DEMODb.

The demodulator DEMODa performs a demodulation process of the signal that is inputted from the intermediate frequency amplifier IF AMPa. The demodulator DEMODa also controls, according to a level of the signal that is inputted into the demodulator DEMODa, a gain of the high frequency amplifier RF AMPa by varying an AGC voltage RF AGCa and a gain of the intermediate frequency amplifier IF AMPa by varying an AGC voltage IF AGCa. That is, the demodulator DEMODa varies the voltage values of the AGC voltages RF AGCa and IF AGCa as appropriate so that gains of the high frequency amplifier RF AMPa and the intermediate frequency amplifier IF AMPa become optimum, thereby obtaining a constant level of the signal that is inputted into the demodulator DEMODa. The demodulator DEMODb performs a demodulation process of the signal that is inputted from the intermediate frequency amplifier IF AMPb. The demodulator DEMODb also controls, according to a level of the signal that is inputted into the demodulator DEMODb, a gain of the high frequency amplifier RF AMPb by varying an AGC voltage RF AGCb and a gain of the intermediate frequency amplifier IF AMPb by varying an AGC voltage IF AGCb. That is, the demodulator DEMODb varies the voltage values of the AGC voltages RF AGCb and IF AGCb as appropriate so that gains of the high frequency amplifier RF AMPb and the intermediate frequency amplifier IF AMPb become optimum, thereby obtaining a constant level of the signal inputted into the demodulator DEMODb.

That is, the first tuner circuit has the same function as a tuner 202A that is provided in the set substrate 200 as illustrated in FIG. 10. The second tuner circuit has the same function as a tuner 202B that is provided to the set substrate 200 as illustrated in FIG. 10.

Here, all of the high frequency amplifiers RF AMPa and RF AMPb and the intermediate frequency amplifiers IF AMPa and IF AMPb are variable gain amplifiers. These variable gain amplifiers may be, for example, variable gain amplifiers each capable of controlling a gain by varying a power consumption.

In this case, a gain of the high frequency amplifier RF AMPa can be varied by varying a voltage value of an AGC voltage RF AGCa. Moreover, a gain of the intermediate frequency amplifier IF AMPa can be varied by varying a voltage value of an AGC voltage IF AGCa. Further, a gain of the high frequency amplifier RF AMPb can be varied by varying a voltage value of an AGC voltage RF AGCb. Moreover, a gain of the intermediate frequency amplifier IF AMPb can be varied by varying a voltage value of an AGC voltage IF AGCb.

Here, the demodulator DEMODa is connected to the voltage comparator CMP1. The demodulator DEMODa outputs the AGC voltages RF AGCa and IF AGCa as control voltages to the voltage comparator CMP1. The AGC voltage RF AGCa is a voltage that the demodulator DEMODa outputs to the high frequency amplifier RF AMPa and the AGC voltage IF AGCa is a voltage that the demodulator DEMODa outputs to the intermediate frequency amplifier IF AMPa.

Moreover, the demodulator DEMODb is connected to the voltage comparator CMP1. The demodulator DEMODb outputs the AGC voltages RF AGCb and IF AGCb as control voltages to the voltage comparator CMP1. The AGC voltage RF AGCb is a voltage that the demodulator DEMODb outputs to the high frequency amplifier RF AMPb and the AGC voltage IF AGCb is a voltage that the demodulator DEMODb outputs to the intermediate frequency amplifier IF AMPb.

The voltage comparator CMP1 receives the AGC voltages RF AGCa, IF AGCa, RF AGCb, and IF AGCb, and determines whether or not the voltage value of each of the AGC voltages is not less than a reference voltage. Then, based on the determination result, the voltage comparator CMP1 outputs a signal to open the switch SW1 or a signal to close the switch SW1 to the switch SW1.

The voltage comparator CMP1 may have an arrangement that employs, for example, the following logic signal.

That is, the AGC voltages RF AGCa, IF AGCa, RF AGCb, and IF AGCb are compared with a reference voltage (threshold value). In case where a result of the comparison satisfies a predetermined condition, either a High level signal or a Low level signal is outputted so as to close a switch. On the other hand, in case where the result of the comparison does not satisfy the predetermined condition, the other one of the High level signal and the Low level signal is outputted so as to open the switch.

A maximum value of each of the AGC voltages that are outputted from the demodulators DEMODa and DEMODb is, for example, 3.3V and a minimum value of each of the AGC voltages that are outputted from the demodulators DEMODa and DEMODb is, for example, 0.5V. In this case, a reference voltage of the voltage comparator CMP1 may be set, for example, at 3V. However, a set value of the reference voltage is not limited to this. The set value of the reference voltage should be set as appropriate according to a tuner characteristic or the like. Further, it is obvious that separate values may be set as the set values of the reference voltages of the AGC voltages RF AGCa, IF AGCa, RF AGCb, and IF AGCb.

The “predetermined condition” for controlling the switch SW1 by the voltage comparator CMP1 is explained later.

Next, an operation of a tuner as illustrated in FIG. 1 is explained.

When the receiving section of the receiver receives an RF signal, the RF signal is inputted into the input terminal 1in.

The RF signal that is inputted into the input terminal 1in is inputted into the broadband amplifier AMP1 in case where the switch SW1 is open. The broadband amplifier AMP1 amplifies the signal that is inputted from the input terminal 1in and outputs the amplified signal to the balun 21.

In case where the switch SW1 is closed, the broadband amplifier AMP1 is short-circuited. That is, the closed switch SW1 short-circuits a line including the switch SW1 that is connected in parallel with the broadband amplifier AMP1. As a result, the RF signal that is inputted into the input terminal Tin bypasses the broadband amplifier AMP1 and is inputted into the balun 21.

The RF signal that is inputted into the balun 21 is outputted to be distributed into the first tuner circuit and the second tuner circuit.

When the signal that is outputted from the balun 21 is inputted into the first tuner circuit, the first tuner circuit performs the same processing as processing that is performed by the tuner 202A provided in the set substrate 200 as illustrated in FIG. 10. When the signal that is outputted from the balun 21 is inputted into the second tuner circuit, the second tuner circuit performs the same processing as processing that is performed by the tuner 202B provided in the set substrate 200 as illustrated in FIG. 10.

Here, the AGC voltage RF AGCa that the demodulator DEMODa outputs for controlling a gain of the high frequency amplifier RF AMPa and the AGC voltage IF AGCa that the demodulator DEMODa outputs for controlling a gain of the intermediate amplifier IF AMPa are inputted into the voltage comparator CMP1. Further, the AGC voltage RF AGCb that the demodulator DEMODb outputs for controlling a gain of the high frequency amplifier RF AMPb and the AGC voltage IF AGCb that the demodulator DEMODb outputs for controlling a gain of the intermediate amplifier IF AMPb are inputted into the voltage comparator CMP1.

As explained above, all of the high frequency amplifiers RF AMPa and RF AMPb and the intermediate frequency amplifiers IF AMPa and IF AMPb are variable gain amplifiers. Moreover, variable gain amplifiers capable of controlling a gain by varying a power consumption are used as such variable gain amplifiers. In general, there is a trade-off relationship between a performance of such a circuit and a power consumption of the circuit. In other words, the performance of the circuit is proportional to the power consumption.

Therefore, in case where a low voltage is inputted into the demodulator DEMODa and/or the demodulator DEMODb, the demodulator DEMODa and/or the demodulator DEMODb raises a gain by increasing the AGC voltage that is provided to the circuit, thereby raising a level of a signal that is inputted into the demodulator DEMODa and/or the demodulator DEMODb. On the other hand, in case where a high voltage is inputted into the demodulator DEMODa and/or demodulator DEMODb, the demodulator DEMODa and/or the demodulator DEMODb lowers a gain by decreasing the AGC voltage that is provided to the circuit, thereby lowering the level of the signal that is inputted into the demodulator DEMODa and/or the demodulator DEMODb.

From this, the levels of the signals that are inputted into the demodulators DEMODa and DEMODb can be clarified by comparing voltage values of the AGC voltages RF AGCa and IF AGCa and the AGC voltages RF AGCb and IF AGCb with a reference voltage with the use of the voltage comparator CMP1. Here, the AGC voltages RF AGCa and IF AGCa are outputted from the demodulator DEMODa, and the AGC voltages RF AGCb and IF AGCb are outputted from the demodulator DEMODb.

Obviously, a low AGC voltage RF AGCa and/or a low AGC voltage IF AGCa indicates that the level of the signal that is inputted into the demodulator DEMODa is high. On the other hand, a high AGC voltage RF AGCa and/or a high AGC voltage IF AGCa indicates that the level of the signal that is inputted into the modulator DEMODa is low. Moreover, a low AGC voltage RF AGCb and/or a low AGC voltage IF AGCb indicates that the level of the signal that is inputted into the demodulator DEMODb is high. On the other hand, a high AGC voltage RF AGCb and/or a high AGC voltage IF AGCb indicates that the level of the signal that is inputted into the modulator DEMODb is low.

The voltage comparator CMP1 determines whether or not each of the inputted AGC voltages RF AGCa, IF AGCa, RF aGCb, and IF AGCb is not less than the reference voltage (e.g. 3V). As shown in Table 1 below, the voltage comparator CMP1 transmits to the switch SW1 a signal to close the switch SW1 in case where both of the AGC voltages IF AGCa and IF AGCb are less than the reference voltage and at least either the AGC voltage RF AGCa or the AGC voltage RF AGCb is less than the reference voltage.

TABLE 1

| FIRST TUNER CIRCUIT | | | SECOND TUNER CIRCUIT | | | CMP1 | | |
|---|---|---|---|---|---|---|---|---|
| | | SIGNAL | | | SIGNAL | COMPARISON | | BALUN 21 |
| RF AGCa | IF AGCa | LEVEL | RF AGCb | IF AGCb | REVEL | RESULT | SW1 | GAIN |
| High | High | Small | High | High | Small | Low | OPEN | Large |
| High | High | Small | High | Low | Intermediate | Low | OPEN | Large |
| High | High | Small | Low | Low | Large | Low | OPEN | Large |
| High | Low | Intermediate | High | High | Small | Low | OPEN | Large |
| High | Low | Intermediate | High | Low | Intermediate | Low | OPEN | Large |
| High | Low | Intermediate | Low | Low | Large | High | CLOSE | Small |
| Low | Low | Large | High | High | Small | Low | OPEN | Large |
| Low | Low | Large | High | Low | Intermediate | High | CLOSE | Small |
| Low | Low | Large | Low | Low | Large | High | CLOSE | Small |

Note that the voltage comparator CMP1 controls the switch SW1 by using a binary logic signal. Here, a level of a signal to open the switch SW1 (a first state of switching means) is assumed to be Low and the level of a signal to close the switch SW1 (a second state of the switching means) is assumed to be High.

In the set substrate 200 as illustrated in FIG. 10, when a very large signal or a very small signal is inputted into the tuners 202A and 202B, the signal that is not controlled to a desired level may be inputted into the demodulators DEMODa and DEMODb.

That is, as explained above, the demodulators DEMODa and DEMODb in the set substrate 200 as illustrated in FIG. 10 increase or decrease the AGC voltage, that the demodulators DEMODa and DEMODb output, so that the gains of the high frequency amplifiers RF AMPa and RF AMPb and the intermediate frequency amplifiers IF AMPa and IF AMPb are raised or lowered, thereby keeping the levels of the signals that are inputted into the demodulators DEMODa and DEMODb constant.

However, a limit value exists for each of the AGC voltage values that are outputted from the demodulators DEMODa and DEMODb and gains of the high frequency amplifiers RF AMPa and RF AMPb and the intermediate frequency amplifiers IF AMPa and IF AMPb. Due to the limit value, the demodulators DEMODa and DEMODb can control the levels of the signals to be a desired level only in a limited range. In case where a signal at a level out of the range is inputted, the demodulators DEMODa and DEMODb cannot control the signal cannot to be a desired level. As a result, a trouble in broadcast reception.

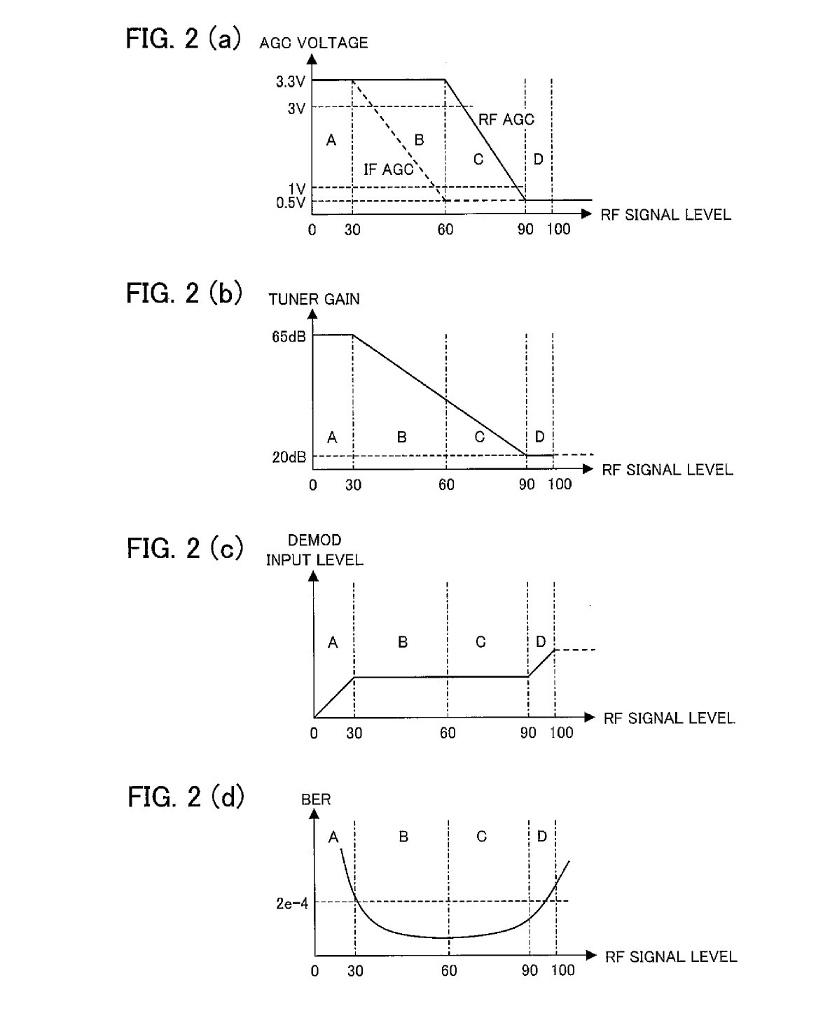

The following explains the problem mentioned above, with reference to FIGS. 2(a) through 2(d).

FIG. 2(a) is a graph illustrating a relationship between a level of an RF signal that is inputted into the tuner and AGC voltages of RF AGC (automatic gain control voltage of a demodulator DEMOD with respect to a high frequency amplifier RF AMP) and IF AGC (automatic gain control voltage of the demodulator DEMOD with respect to an intermediate frequency amplifier IF AMP) of the demodulator DEMOD. FIG. 2(b) is a graph illustrating a relationship between a level of the RF signal that is inputted into the tuner and a gain of an entire tuner. FIG. 2(c) is a relationship between a level of the RF signal that is inputted into the tuner and a level of a signal that is inputted into the demodulator DEMOD.

First, when the level of the signal that is inputted into the tuner is very small, that is, when the signal level is in a region A, both of the AGC voltages RF AGC and IF AGC of the demodulator DEMOD become maximum (e.g. 3.3V). The gain of the entire tuner also becomes maximum (e.g. 65 dB). However, the level of the signal that is inputted into the demodulator DEMOD does not rise up to a desired value. Therefore, an error occurs in the demodulator DEMOD. This causes a trouble in broadcast reception.

Next, when the level of the signal that is inputted into the tuner is rather small, that is, when the signal level is in a region B, the AGC voltage RF AGC of the demodulator DEMOD becomes maximum and a gain of the high frequency amplifier RF AMP becomes maximum. On the other hand, the AGC voltage IF AGC of the demodulator DEMOD becomes smaller in proportion to the level of the signal that is inputted into the tuner. Accordingly, a gain of the intermediate amplifier IF AMP lowers. As a result, the signal that is inputted into the tuner is appropriately controlled in terms of a gain by the high frequency amplifier RF AMP and the intermediate frequency amplifier IF AMP, and the signal that is inputted into the demodulator DEMOD is kept at a constant level.

When the level of the signal that is inputted into the tuner is rather large, that is, when the signal level is in a region C, the AGC voltage of the high frequency amplifier RF AMP decreases in proportion to the level of the signal that is inputted into the tuner. Accordingly, a gain of the high frequency amplifier RF AMP lowers. On the other hand, the AGC voltage IF AGC of the demodulator DEMOD becomes minimum, and a gain of the intermediate frequency amplifier IF AMP becomes minimum (e.g. 0.5V). As a result, the signal that is inputted into the tuner is appropriately controlled in terms of a gain by the high frequency amplifier RF AMP and the intermediate frequency amplifier IF AMP, and the signal that is inputted into the demodulator DEMPD is kept at a constant level.

When the level of the signal that is inputted into the tuner is very large, that is, when the level of the signal is in a region D, both the AGC voltages RF AGC and IF AGC of the demodulator DEMOD become minimum. A gain of the entire tuner also becomes minimum (e.g. 20 dB). However, the level of the signal that is inputted into the demodulator DEMOD does not lower up to a level of a desired value. As a result, an error occurs in the demodulator DEMOD, and this causes a problem in broadcast reception.

When, the level of the signal that is inputted into the tuner becomes larger than the level of the signal in the region D, the level of the signal reaches a saturation voltage of the tuner. That is, the level of the signal that is inputted into the tuner exceeds a level of a voltage that the tuner can receive. Therefore, the level of the signal that is inputted into the demodulator DEMOD does not rise to a level higher than a specific level.

FIG. 2(d) is a graph illustrating a relationship between a level of the RF signal that is inputted into the tuner and a BER (bit error rate) of a signal inputted into the demodulator DEMOD. Although the BER is stable at a low (roughly, a bit error number is not more than 2, that is, the BER value is not more than 2e⁻⁴ after demodulation with respect to a transmitted 10⁴-bit signal) value in the regions B and C, the BER drastically increases in the regions A and D. That is, when a very large signal or a very small signal is inputted into the tuner (particularly when a very small signal is inputted into the tuner), a noise factor of the signal that is inputted into the demodulator DEMOD deteriorates. This deteriorates the sensitivity of the tuner itself.

From this, the signals that are inputted into the demodulators DEMODa and DEMODb need to be kept in the region B or C. Accordingly, levels of signals that are inputted into the demodulators DEMODa and DEMODb are detected by comparing each of the AGC voltages that are outputted from the demodulators DEMODa and DEMODb with the reference voltage.

In case where both the AGC voltages IF AGCa and IF AGCb are not more than the reference voltage and at least either the AGC voltage RF AGCa or the AGC voltage RF AGCb is not more than the reference voltage, the switch SW1 is closed and the broadband amplifier AMP1 is bypassed. In this case, the RF signal that is inputted via the input terminal 1in is outputted to the balun 21 in a state that the RF signal is not amplified. In a case other than the above case, the switch SW1 is opened and the RF signal is amplified with the use of the broadband amplifier AMP1. The amplified RF signal is outputted to the balun 21.

This allows the balun 21 to appropriately output the REF signal at a level desirable to the first and second tuner circuits according to reception states of the first and second tuners. The signal that is outputted from the balun 21 is appropriately controlled in terms of a gain by the high frequency amplifiers RF AMPa and RF AMPb and the intermediate frequency amplifier IF AMPa and IF AMPb. As a result, each of the signals that are inputted into the demodulators DEMODa and DEMODb is kept at a constant level.

In the present embodiment, as shown in Table 1, the voltage comparator CMP1 transmits a signal to close the switch SW1 to the switch SW1, when both of the AGC voltages IF AGCa and IF AGCb are not more than the reference voltage and at least either the AGC voltage RE AGCa or the AGC voltage RF AGCb is not more than the reference voltage.

However, a control method of switching of the switch SW1 is not limited to this. That is, for example, when one of the AGC voltages IF AGCa and IF AGCb is not more than the reference voltage, a signal to close the switch SW1 may be transmitted to the switch SW1.

The control of the switch SW1 by the voltage comparator CMP1 may be performed at any timing. However, the control is preferably performed once as a routine every time a broadcast is selected, that is, a receive channel is changed. This makes it possible to supply a signal at a desired level to the first and second tuner circuits even in case where the receive channel of the receiver is changed.

In this way, according to variation in the levels of the signals that are inputted into the demodulators DEMODa and DEMODb, the level of the signal that the balun 21 outputs to distribute can be controlled to a level desirable to the first and second tuner circuits.

Moreover, the input terminal 1in of the tuner 10 is connected to the receiver in a state without wiring, and the distributor is included in the tuner 10. Therefore, the number of coaxial cables can be reduced.

Accordingly, cost increase due to the use of a plurality of coaxial cables can be suppressed and material cost and man-hour can be reduced.

### Embodiment 2

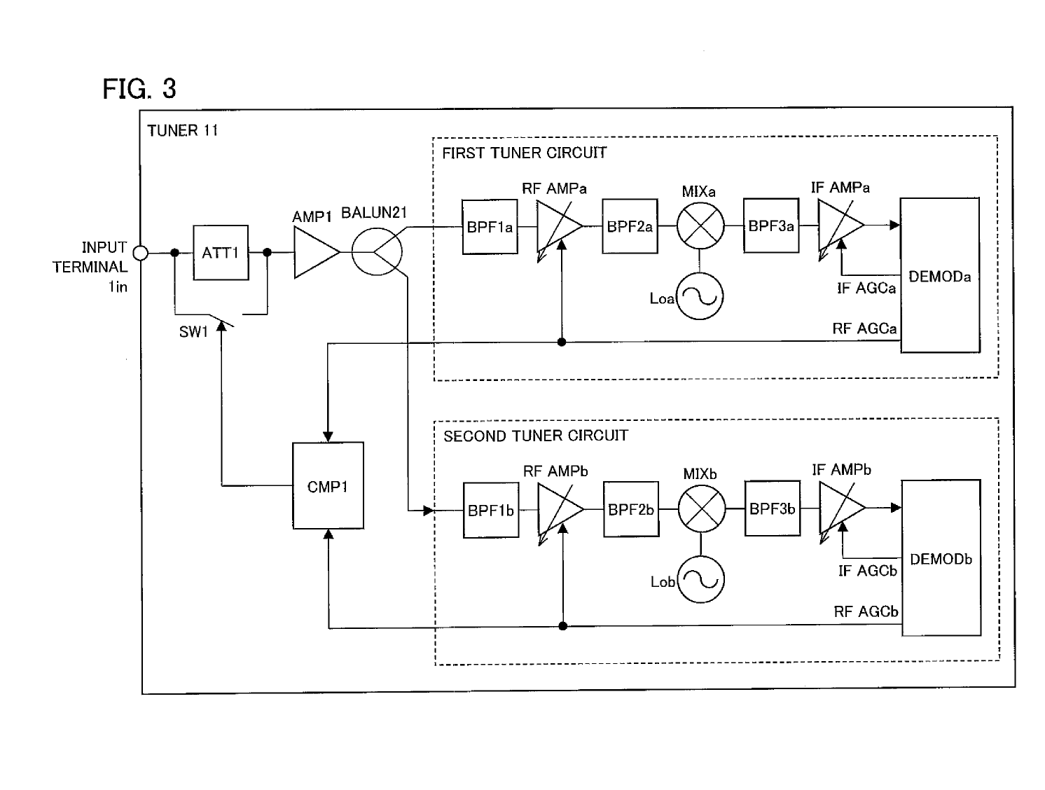

FIG. 3 is a circuit block diagram of another tuner of the present invention.

A tuner 11 as illustrated in FIG. 3 includes a series circuit composed of a parallel circuit, which is made of an attenuator ATT1 and a switch SW1, and a broadband amplifier AMP1 between an input terminal 1in and a balun 21. The series circuit is provided in lieu of a parallel circuit which is made of the broadband amplifier AMP1 and the switch SW1 in a tuner 10 as illustrated in FIG. 1 and connected to the input terminal tin and the balun 21 in series.

The attenuator ATT1 attenuates an RF signal that is inputted from the input terminal 1in. The attenuator ATT1 may be any attenuator as long as the attenuator can attenuates the signal that is inputted into the attenuator. Any attenuator in a known arrangement may be used as such an attenuator. Moreover, an attenuation amount of the attenuator ATT1 is preferably set, for example, in a range of 5 dB to 15 dB (that is, the attenuator ATT1 attenuates the signal that is inputted into the attenuator ATT1 by 5 dB to 15 dB). However, the attenuation amount is not limited to this. In other words, the attenuation amount of the attenuator ATT1 can be set as appropriate according to a tuner characteristic or the like.

A demodulator DEMODa is connected to a voltage comparator CMP1 and outputs an AGC voltage RF AGCa to the voltage comparator CMP1. The AGC voltage RF AGCa is a voltage that the demodulator DEMODa outputs to a high frequency amplifier RF AMPa. Further, a demodulator DEMODb is connected to the voltage comparator CMP1 and outputs an AGC voltage RF AGCb to the voltage comparator CMP1. The AGC voltage RF AGCb is a voltage that the demodulator DEMODb outputs to the high frequency amplifier RF AMPb.

The voltage comparator CMP1 receives the AGC voltages RF AGCa and RF AGCb and determines whether or not each voltage value is not less than the reference voltage (e.g. 3V). Based on the determination result, the voltage comparator CMP1 outputs to the switch SW1 a signal to open the switch SW1 or a signal to close the switch SW1.

The AGC voltage RF AGCa that the demodulator DEMODa outputs for controlling a gain of the high frequency amplifier RF AMPa is inputted into the voltage comparator CMP1. Further, the AGC voltage RF AGCb that the demodulator DEMODb outputs for controlling a gain of the high frequency amplifier RF AMPb is inputted into the voltage comparator CMP1.

The voltage comparator CMP1 determines whether or not each of the voltage values of the inputted AGC voltages RF AGCa and RF AGCb is not less than the reference voltage. As shown in Table 2 below, the voltage comparator CMP1 transmits to the switch SW1 a signal to open the switch SW1 in case where both of the AGC voltages RF AGCa and RF AGCb are not more than the reference voltage.

TABLE 2

| FIRST | | SECOND | | CMP1 | | |
|---|---|---|---|---|---|---|
| TUNER CIRCUIT | | TUNER CIRCUIT | | COMPARISON | | BALUN |
| RF AGCa | SIGNAL LEVEL | RF AGCb | SIGNAL LEVEL | RESULT | SW1 | 21 GAIN |
| High | Small | High | Small | Low | CLOSE | Large |
| High | Small | Low | Large | Low | CLOSE | Large |
| Low | Large | High | Small | Low | CLOSE | Large |
| Low | Large | Low | Large | High | OPEN | Small |

Note that the voltage comparator CMP1 is assumed to control the switch SW1 with a binary logic signal. Here, the signal to open the switch SW1 (a first state of switching means) is assumed to be High and a signal to close the switch SW1 (a second state of the switching means) is assumed to be Low.

Accordingly, when the level of the signal that is inputted into the first and/or second tuner circuit is small, the switch SW1 is closed and the attenuator ATT1 is bypassed. The RF signal that is inputted via the input terminal 1in and not attenuated by the attenuator ATT1 is amplified by the broadband amplifier AMP1. The amplified RF signal is outputted to the balun 21. When both of the levels of the signals that are inputted into the first and second tuner circuits are large, the switch SW1 is opened and the RF signal is attenuated by the attenuator ATT1. Then, the attenuated RF signal is amplified by the broadband amplifier, and outputted to the balun 21.

This allows the balun 21 to appropriately output the RF signal at a level desirable to the first and second tuner circuits according to reception states of the first and second tuner circuits. The signal that is outputted from the balun 21 is controlled as appropriate in terms of a gain by the high frequency amplifiers RF AMPa and RF AMPb and the intermediate frequency amplifiers IF AMPa and IF AMPb. The levels of the signals that are inputted into the demodulators DEMODa and DEMODb are kept constant.

In the present embodiment, as shown in Table 2, the voltage comparator CMP1 transmits to the switch SW1 a signal to close the switch SW1, when both of the AGC voltages RF AGCa and RF AGCb are not more than the reference voltage.

However, a control method of switching of the switch SW1 is not limited to this. That is, for example, when the AGC voltage RF AGCa and/or the AGC voltage RF AGCb is not more than the reference voltage, a signal to close the switch SW1 may be transmitted to the switch SW1.

Moreover, in the present embodiment, only the AGC voltages RF AGCa and RF AGCb are inputted into the voltage comparator CMP1.

However, a combination of the voltage values that are inputted into the voltage comparator CMP1 is not limited to this. That is, as in the Embodiment that is illustrated in FIG. 1 and explained above, the voltage comparator CMP1 may be arranged such that the AGC voltages RF AGCa, RF AGCb, IF AGCa, and IF AGCb are inputted into the voltage comparator CMP1. In this case, for example, when both of the AGC voltages RF AGCa and RF AGCb are not more than the reference voltage and at least either the AGC voltage IF AGCa or the AGC voltage IF AGCb is not more than the reference voltage, the signal to close the switch SW1 is transmitted to the switch SW1.

The control of the switch SW1 by the voltage comparator CMP1 may be performed at any timing. However, the control is preferably performed once as a routine every time a broadcast is selected, that is, a receive channel is chanted. This makes it possible to supply a signal at a desired level to the first and second tuner circuits even when the receive channel of a receiver is changed.

In this way, according to variation in the levels of the signals that are inputted into the demodulators DEMODa and DEMODb, the level of the signal that the balun 21 outputs to distribute can be controlled to a level desirable to the first and second tuner circuits.

Moreover, the input terminal 1in of the tuner 11 is connected to the receiver in a state without wiring, and a distributor is included in the tuner 11. Therefore, the number of coaxial cables can be reduced.

Accordingly, cost increase due to the use of a plurality of coaxial cables can be suppressed and material cost and man-hour can be reduced.

### Embodiment 3

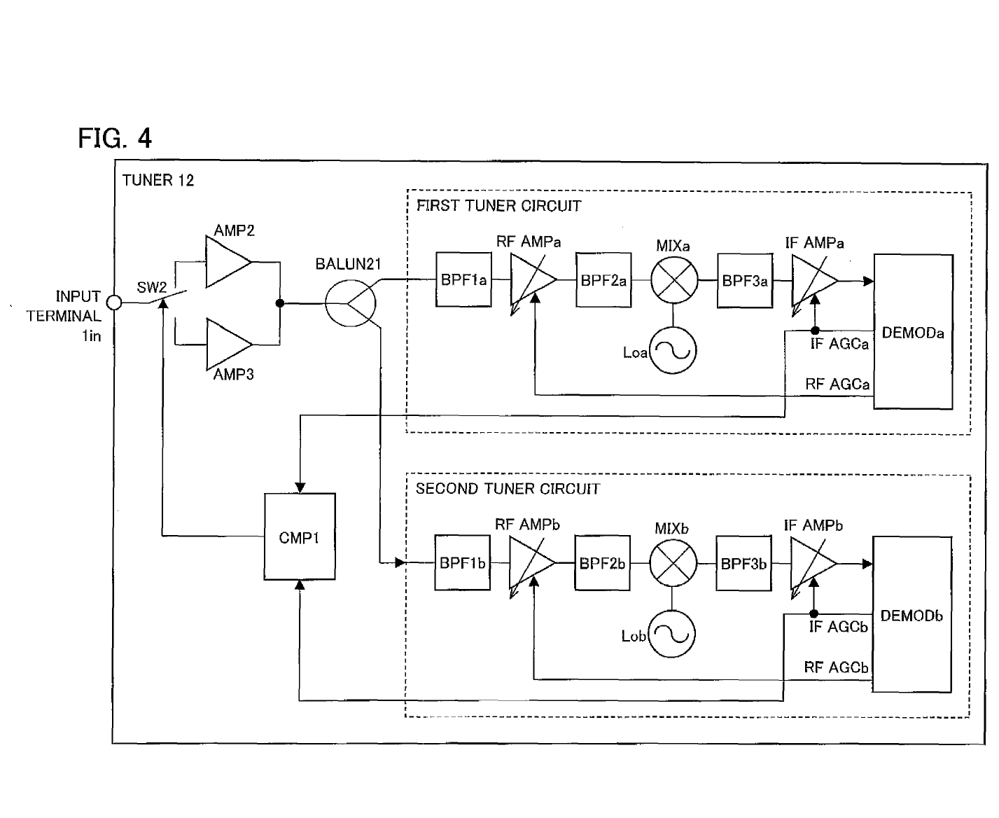

FIG. 4 is a circuit block diagram of another tuner according to the present invention.

The tuner 12 as illustrated in FIG. 4 includes a parallel circuit that is composed of a broadband amplifier (first amplifier) AMP2 and a broadband amplifier (second amplifier) AMP3 between an input terminal 1in and a balun 21. The parallel circuit is provided in lieu of a parallel circuit which is composed of the broadband amplifier AMP1 and the switch SW1 in a tuner 10 as illustrated in FIG. 1 and connected to the input terminal Tin and the balun 21 in series. Further, a connecting section on a side provided with the input terminal 1in of the parallel circuit is made of a switch SW2 (switching means).

The broadband amplifier AMP2 amplifies an RF signal that is inputted via the input terminal 1in. The broadband amplifier AMP2 may be any broadband amplifier as long as the broadband amplifier is capable of amplifying the signal that is inputted into the broadband amplifier. Any broadband amplifier in a known arrangement may be used as such a broadband amplifier.

The broadband amplifier AMP3 amplifies an RF signal that is inputted via the input terminal Tin. The broadband amplifier AMP3 may be any broadband amplifier as long as the broadband amplifier is capable of amplifying the signal that is inputted into the broadband amplifier. Any broadband amplifier in a known arrangement may be used as such a broadband amplifier.

Note that the broadband amplifiers AMP2 and AMP3 need to have different gain characteristics. In other words, an amplification degree of the broadband amplifier AMP2 needs to be different from an amplification degree of the broadband amplifier AMP3. The amplifier having a larger amplification degree needs to largely amplify a low level signal and decreases a noise factor of the signal. On the other hand, the amplifier having a smaller amplification degree amplifies a high level signal a little and suppresses distortion due to the amplification. Here, it is assumed that the broadband amplifier AMP2 is an amplifier having a larger amplification degree and the broadband amplifier AMP3 is an amplifier having a smaller amplification degree. Obviously, the broadband amplifiers AMP2 and AMP3 may be arranged as a combination in a reverse way. Moreover, a gain of the broadband amplifier AMP2 is preferably set, for example, in a range from 10 dB to 20 dB and a gain of the broadband amplifier AMP3 is preferably set, for example, in a range from 5 dB to 10 dB. However, the arrangement is not limited to this. That is, the gains of the broadband amplifiers AMP2 and AMP3 should be set as appropriate according to the tuner characteristic and the like.

The switch SW2 is made of a monopolar switching switch that performs, for example, a c-contact operation. Based on a control signal from a voltage comparator CMP1, the switch SW2 switches between a state in which the switch SW2 is connected to the broadband amplifier AMP2 and a state in which the switch SW2 is connected to the broadband amplifier AMP3. Any switch may be the switch SW2 as long as the switch can perform switching according to a signal transmitted from the voltage comparator CMP1. Any switch capable of performing such switching in a publicly known arrangement may be used as the switch SW2. Obviously, the switch SW2 is not limited to a monopolar switching switch that performs a c-contact operation.

A demodulator DEMODa is connected to the voltage comparator CMP1 and outputs to the voltage comparator CMP1 an AGC voltage IF AGCa that the demodulator DEMODa outputs to the intermediate frequency amplifier IF AMPa.

Moreover, a demodulator DEMODb is connected to the voltage comparator CMP1 and outputs to the voltage comparator CMP1 an AGC voltage IF AGCb that the demodulator DEMODb outputs to the intermediate frequency amplifier IF AMPb.

The voltage comparator CMP1 receives the AGC voltages IF AGCa and IF AGCb and determines whether or not each voltage value is not less than a reference voltage (e.g. 3V). Then, based on the determination result, the voltage comparator CMP1 outputs, to the switch SW2, a signal to connect the switch SW2 to the broadband amplifier AMP2 or a signal to connect the switch SW2 to the broadband amplifier AMP3.

The voltage value of the AGC voltage IF AGCa that the demodulator DEMODa outputs for controlling a gain of the intermediate frequency amplifier IF AMPa is inputted into the voltage comparator CMP1. Further, the voltage value of the AGC voltage IF AGCb that the demodulator DEMODb outputs for controlling a gain of the intermediate frequency amplifier IF AMPb is inputted into the voltage comparator CMP1.

The voltage comparator CMP1 determines whether or not each of the voltage values of the inputted AGC voltages IF AGCa and IF AGCb are not less than the reference voltage (e.g. 3V). Then, as shown in Table 3 below, the voltage comparator CMP1 transmits to the switch SW2 a signal to connect the switch SW2 to the broadband amplifier AMP2, when both of the AGC voltages IF AGCa and IF AGCb are not less than the reference voltage.

TABLE 3

| FIRST | | SECOND | | | | |
|---|---|---|---|---|---|---|
| TUNER CIRCUIT | | TUNER CIRCUIT | | CMP1 | BROADBAND | |
| | SIGNAL | | SIGNAL | COMPARISON | AMPLIFIER | BALUN 21 |
| IF AGCa | LEVEL | IF AGCb | LEVEL | RESULT | SELECTION | GAIN |
| High | Small | High | Small | Low | AMP2 | Large |
| High | Small | Low | Large | High | AMP3 | Small |
| Low | Large | High | Small | High | AMP3 | Small |
| Low | Large | Low | Large | High | AMP3 | Small |

Here, the voltage comparator CMP1 is assumed to control the switch SW2 by using a binary logic signal. A signal to connect the switch SW2 to the broadband amplifier AMP2 (a first state of switching means) is assumed to be Low and a signal to connect the switch SW2 to the broadband amplifier AMP3 (a second state of the switching means) is assumed to be High.

Accordingly, when the level of the signal that is inputted into the first and/or second tuner circuit is small, the balun 21 receives an RF signal that is inputted via the input terminal tin and largely amplified by the broadband amplifier AMP2. On the other hand, when the level of the signal that is inputted into the first and/or second tuner circuit is large, the balun 21 receives an RF signal that is amplified a little by the broadband amplifier AMP3.

This allows the balun 21 to appropriately output the RF signal at a level desirable to the first and second tuner circuits according to reception states of the first and second tuner circuits. The signal that is outputted from the balun 21 is controlled appropriately in terms of a gain by the high frequency amplifiers RF AMPa and RF AMPb, and the intermediate frequency amplifiers IF AMPa and IF AMPb. The levels of signals that are inputted into the demodulators DEMODa and DEMODb are kept constant.

The present embodiment has an arrangement that includes two broadband amplifiers including the broadband amplifiers AMP2 and AMP3 in a preceding stage of the balun 21. However, the arrangement is not limited to this. According to need, more than two broadband amplifiers may be provided in the arrangement.

For example, in case where n broadband amplifiers are provided, the voltage comparator CMP1 may have an arrangement in which a degree of amplification by the broadband amplifier is switched by n steps, by performing n-step switching of the switch SW2 according to the inputted AGC voltages IF AGCa and IF AGCb.

Moreover, in the present embodiment, as shown in Table 3, the voltage comparator CMP1 transmits to the switch SW2 a signal to connect the switch SW2 to the broadband amplifier AMP2 only when both of the AGC voltages IF AGCa and IF AGCb are not less than the reference voltage.

However, a method of controlling whether to connect the switch SW2 to the broadband amplifier AMP2 or AMP3 is not limited to this. In other words, for example, the voltage comparator CMP1 may be arranged to transmit to the switch SW2 a signal to connect the switch SW2 to the broadband amplifier AMP2 in case where the AGC voltage IF AGCa and/or the AGC voltage IF AGCb is not less than the reference voltage.

Further, modification of the arrangement of the broadband amplifier AMP2 may allow realization of a broadband amplifier (variable amplifier) AMP4 that is capable of performing sequential switching of a gain.

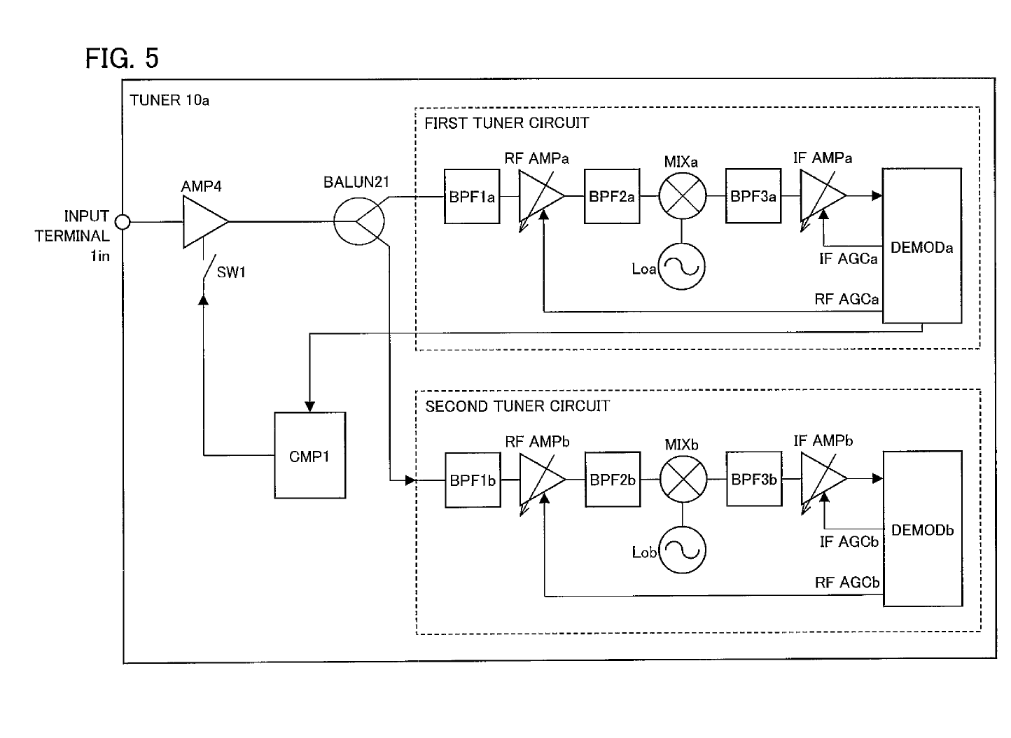

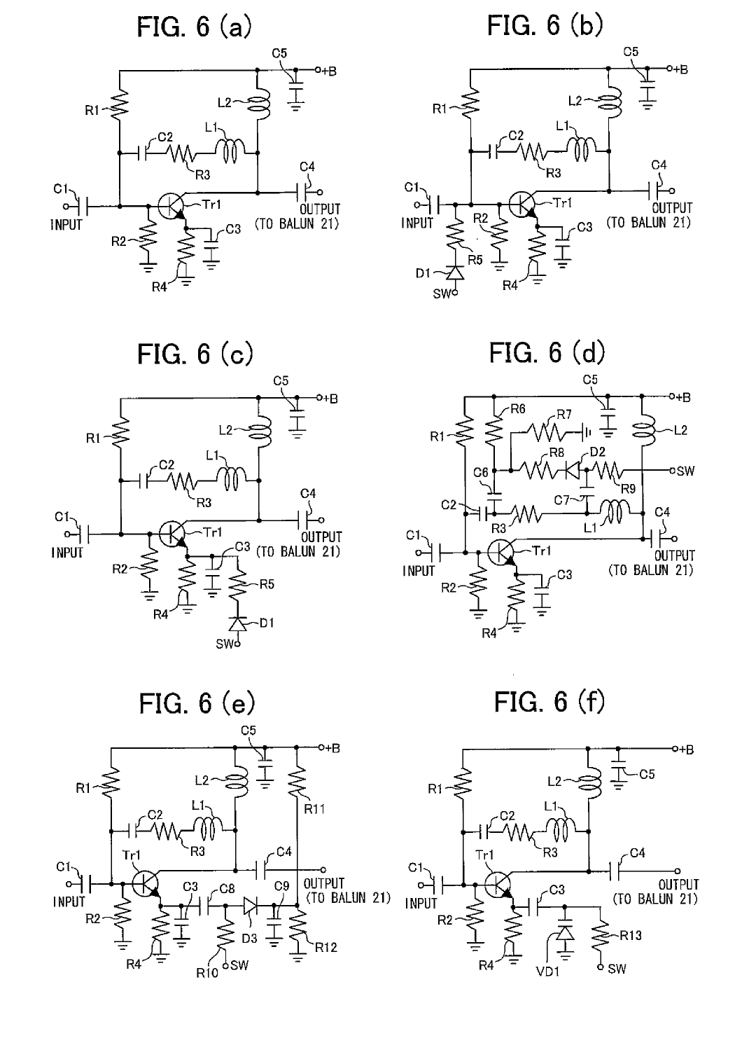

That is, as in a tuner 10a as illustrated in FIG. 5, only a broadband amplifier AMP4 is provided between the input terminal 1in and the balun 21. The broadband amplifier AMP4 has an arrangement as illustrated in any one of FIGS. 6(a) through 6(e) explained later. Further, the switch SW1 that is used in the Embodiment explained above is connected in series between the broadband amplifier AMP4 and the voltage comparator CMP1.

The voltage comparator CMP1 applies a gain control voltage (a voltage to control a gain of the broadband amplifier AMP4 (the gain of the broadband amplifier AMP4 varies in accordance with the voltage value of the gain control voltage)) to a predetermined terminal of the broadband amplifier AMP4. The voltage comparator CMP1 controls switching of the switch SW1, based on at least one or all of the voltage values of the AGC voltages RF AGCa, RF AGCb, IF AGCa, and IF AGCb. FIG. 5 illustrates as an example a case where the AGC voltage RF AGCa and/or the AGC voltage IF AGCa is inputted into the voltage comparator CMP1.

In a state where the switch SW1 closes (a first state of the switching means), the voltage comparator CMP1 is electrically connected to the broadband amplifier AMP4. As a result, a gain control voltage is applied to the broadband amplifier AMP4 and a gain of the broadband amplifier AMP4 rises. This largely amplifies a signal.

In a state where the switch SW1 is open (a second state of the switching means), the voltage comparator CMP1 is not electrically connected to the broadband amplifier AMP4. As a result, the gain control voltage is not applied to the broadband amplifier AMP4 and the gain of the broadband amplifier AMP4 does not rise. Consequently, the signal is not much amplified.

According to the arrangement above, the arrangement in which only the broadband amplifier AMP4 is provided can provide substantially the same effect as that of the Embodiment in which the broadband amplifiers AMP2 and AMP3 are provided. This allows a signal distribution device of the present embodiment to be realized by using a simple circuit.

Here briefly explained is one example of the arrangement of the broadband amplifier AMP4, with reference to FIGS. 6(a) through 6(f).

First, a circuit as illustrated in FIG. 6(a) is a current feedback bias transistor amplifying circuit that includes a feedback circuit providing feedback from a collector of a transistor Tr1 to a base thereof. The current feedback bias transistor amplifying circuit becomes a part of an arrangement of the broadband amplifier that is preferably used as the broadband amplifier AMP4 as illustrated in each of FIGS. 6(b) through 6(f).

The broadband amplifier includes the transistor Tr1. The base of the transistor Tr1 is connected to the input terminal 1in (See FIG. 5) via a condenser C1. The base of the transistor Tr1 is also connected to one end of the resistor R2. The other end of the resistor R2 is kept at a ground potential. The collector of the transistor Tr1 is connected to an output terminal via a condenser C4. An emitter of the transistor Tr1 is connected to one end of a resistor R4 and one end of a condenser C3. The transistor R4 and the condenser C3 are provided in parallel to each other. The other end of the transistor R4 and the other end of the condenser C3 are kept at a ground potential.

In the broadband amplifier, a feedback circuit providing feedback from the collector of the transistor Tr1 to the base thereof. This feedback circuit includes an inductance L1, a resistor R3, and a condenser C2. One end of the inductance L1 is connected to the collector of the transistor Tr1 and the other end of the inductance L1 is connected to one end of the resistor R3. The other end of the resistor R3 is connected to one end of the condenser C2. The other end of the condenser C2 is connected to the base of the transistor Tr1.

The collector of the transistor Tr1 is further connected to one end of an inductance L2. The other end of the inductance L2 is connected to a terminal +B to which a voltage source is connected. The base of the transistor Tr1 is further connected to one end of a resistor R1. The other end of the resistor R1 is connected to the terminal +B. The terminal +B is further connected to one end of a condenser C5 and the other end of the condenser C5 is kept at a ground potential.

The broadband amplifiers as illustrated in each of FIGS. 6(b) through 6(f) further includes the following arrangement, in addition to the current feedback bias transistor amplifying circuit that has the arrangement of FIG. 6(a) and includes a feedback circuit providing feedback from the collector of the transistor Tr1 to the base thereof.

The broadband amplifier as illustrated in FIG. 6(b) further includes a resistor R5 and a diode D1. One end of the resistor R5 is connected to the base of the transistor Tr1 and the other end of the resistor R5 is connected to a cathode of the diode D1. An anode of the diode D1 is connected to an input terminal (a predetermined terminal of an amplifier) SW to which a voltage that is outputted from the voltage comparator CMP1 is inputted.

In the broadband amplifier as illustrated in FIG. 6(b), a bias voltage that is applied to the base of the transistor Tr1 is overlapped with a voltage that is inputted from the terminal SW. This varies a base voltage of the transistor Tr1. As a result, it becomes possible to control the gain of the broadband amplifier.

The broadband amplifier as illustrated in FIG. 6(c) further includes a resistor R5 and a diode D1. One end of the resistor R5 is connected to the emitter of the transistor Tr1, and the other end of the resistor R5 is connected to a cathode of the diode D1. An anode of the diode D1 is connected to an input terminal (a predetermined terminal of an amplifier) SW to which a voltage that is outputted from the voltage comparator CMP1 is inputted.

In the broadband amplifier as illustrated in FIG. 6(c), an emitter voltage of the transistor Tr1 is varied so that a base voltage of the transistor Tr1 is varied. This makes it possible to control a gain of the broadband amplifier.

The broadband amplifier as illustrated in FIG. 6(d) further includes resistors R6, R7, R8, and R9, and condensers C6 and C7, and a diode D2. One end of the condenser C6 is connected between the condenser C2 and the resistor R3. The other end of the condenser C6 is connected to one end of the resistor R6. The other end of the resistor R6 is connected to the terminal +B to which a voltage source is connected. Between the condenser C6 and the resistor R6, one end of the resistor R7 and one end of the resistor R8 are connected. The resistors R7 and R8 are disposed in parallel to each other. The other end of the resistor R7 is kept at a ground potential. A cathode of the diode D2 is connected to the other end of the resistor R8. An anode of the diode D2 is connected to the input terminal SW via the resistor R9. To the input terminal SW, a voltage that is outputted from the voltage comparator CMP1 is inputted. The anode of the diode D2 is further connected to one end of the condenser C7. The other end of the condenser C7 is connected to one end of the inductance L1 on a side provided with the resistor R3.

In the broadband amplifier as illustrated in FIG. 6(d), a base voltage of the transistor Tr1 is varied by varying a value of a feedback resistance (impedance) in the feedback bias transistor amplifying circuit that includes a feedback circuit providing feedback from the collector to the base of FIG. 6(a). This makes it possible to control a gain of the broadband amplifier.

The broadband amplifier as illustrated in FIG. 6(e) further includes resistors R10, R11, and R12, condensers C8 and C9, and a diode D3. The emitter of the transistor Tr1 is further connected to one end of the condenser C8. The other end of the condenser C8 is connected to an anode of the diode D3. Moreover, the other end of the condenser C8 is connected to one end of the transistor R10. The other end of the transistor R10 is connected to the input terminal SW to which a voltage that is outputted from the voltage comparator CMP1 is inputted. One end of the condenser C9 is connected to a cathode of the diode D3. The other end of the condenser C9 is kept at a ground potential. Further, the cathode of the diode D3 is connected to one end of the resistor R11 and one end of the resistor R12. The other end of the resistor R11 is connected to the terminal +B to which a voltage source is connected. The other end of the resistor R12 is kept at a ground potential.

In the broadband amplifier as illustrated in the broadband amplifier as illustrated in FIG. 6(e), the emitter voltage is varied by varying a value of the emitter resistance of the transistor Tr1. Moreover, the variation in the emitter voltage varies the base voltage of the transistor Tr1. This makes it possible to control a gain of the broadband amplifier.

The broadband amplifier as illustrated in FIG. 6(f) further includes a resistor R13 and a variable capacitor diode VD1. The variable capacitor diode VD1 is connected between the condenser C3 and a ground plane of the condenser C3. In other words, a cathode of the variable capacitor diode VD1 is connected to a terminal of the condenser C3 which terminal is on a side opposite from the transistor Tr1, and an anode of the variable capacitor diode VD1 is kept at a ground potential. One end of the resistor R13 is connected between the condenser C3 and the cathode of the variable capacitor diode VD1, and the other end of the resistor R13 is connected to the input terminal SW to which a voltage that is outputted from the voltage comparator CMP1 is inputted.

In the broadband amplifier as illustrated in FIG. 6(f), a value of the emitter grounding capacitance is varied by varying a capacitance of the variable capacitor diode VD1 so that the variation in the value of the emitter grounding capacitance varies the emitter voltage. Subsequently, the variation in the emitter voltage varies the base voltage of the transistor Tr1. This makes it possible to control the gain of the broadband amplifier. Note that the broadband amplifier as illustrated in FIG. 6(f) may include a condenser in lieu of the variable capacitor diode VD1 or both of the variable capacitor diode VD1 and a condenser. In case where the condenser is included, the value of the emitter grounding capacitance is varied by varying the capacitance of the condenser. The variation in the value of the emitter grounding capacitance varies the emitter voltage. This variation in the emitter voltage varies the base voltage of the transistor Tr1. This makes it possible to control a gain of the broadband amplifier.

Any one of the circuits as illustrated in FIGS. 6(a) through 6(f) can be obtained by one or a combination of known arrangements. Therefore, the explanations of operations and functions thereof are omitted here.

The broadband amplifier as illustrated in any one of amplifier AMP4 and the level of the signal that is outputted from the voltage comparator CMP1 is switched by many steps according to a comparison result of the AGC voltage in the voltage comparator CMP1. This allows the broadband amplifier AMP4 to perform multi-step gain switching. In this case, an operation to switch a gain of the broadband amplifier AMP4 according to a signal that is outputted from the voltage comparator CMP1 is substantially the same as the operations of the FIGS. 6(b) through 6(f) as explained above. Therefore, the explanation does not go into detail here.

In the present embodiment, the voltage comparator CMP1 has an arrangement in which only the AGO voltages IF AGCa and IF AGCb are inputted into the voltage comparator CMP1.

However, a combination of the voltage values that are inputted into the voltage comparator CMP1 is not limited to this. Namely, for example, as in the embodiment as illustrated in FIG. 1 explained above, the voltage comparator CMP1 may have an arrangement in which the AGC voltages RF AGCa, IF AGCa, RF, AGCb, and RF AGCb are inputted into the voltage comparator CMP1. In this case, for example, the voltage comparator CMP1 may output to the switch SW2 a signal to connect the switch SW2 to the broadband amplifier AMP2 in case where both the AGC voltages IF AGCa and IF AGCb are not less than the reference voltage and at least one of the AGC voltages RF AGCa and RF AGCb are not less than the reference voltage.

The control of the switch SW1 and/or the switch SW2 by the voltage comparator CMP1 may be performed at any timing. However, it is preferable to perform the control once as a routine every time a broadcast is selected, that is, a receive channel is changed. This makes it possible to provide a signal at a desirable level to the first and second tuner circuits even in a case where the receive channel of a receiver is changed.

In this way, the level of the signal that the balun 21 outputs to distribute can be controlled to the level desirable to the first and the second tuner circuits according to variation in the levels of the signals that are inputted into the demodulators DEMODa and DEMODb.

Moreover, the input terminal 1in of the tuner 12 or 10a is connected to the receiver in a state without wiring and a distributor is further included in the tuner 12 or 10a. Accordingly, the number of coaxial cables can be reduced.

Therefore, cost increase due to the use of a plurality of coaxial cables can be suppressed and material cost and man-hour can be reduced.

### Embodiment 4

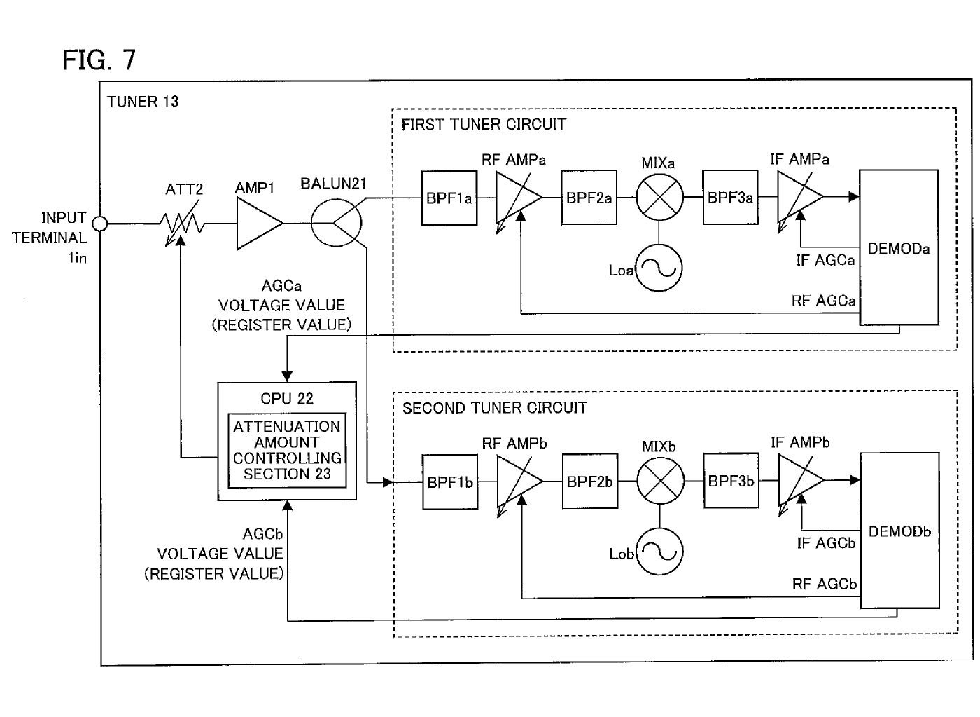

FIG. 7 is a circuit block diagram of another tuner of the present invention.

A tuner 13 as illustrated in FIG. 7 includes a series circuit that is composed of an variable attenuator ATT2 and a broadband amplifier AMP1 between an input terminal Tin and a balun 21. The series circuit is provided in lieu of a parallel circuit that is composed of a broadband amplifier AMP1 and a switch SW1 in a tuner 10 as illustrated in FIG. 1 and connected to the input terminal 1in and the balun 21 in series. Moreover, the tuner 13 includes a CPU (Central Processing Unit, voltage comparison control means) 22 in lieu of a voltage comparator CMP1.

The variable attenuator ATT2 attenuates an RF signal that is inputted from the input terminal 1in. The variable attenuator ATT2 is, for example, a variable attenuator capable of controlling an attenuation amount by varying a power consumption. It is preferable that the attenuation amount of the variable attenuator ATT2 is varied in a range from 0 dB to 15 dB. However, the range of the attenuation amount is not limited to this. That is, the range of the attenuation amount that the variable attenuator ATT2 can vary may be set as appropriate the variable attenuator ATT2 can vary the attenuation amount by varying the power consumption of the variable attenuator ATT2, in accordance with a control signal from the CPU 22 explained later. A specific configuration example of the variable attenuator ATT2 is explained later.

A demodulator DEMODa is connected to the CPU 22 and outputs to the CPU 22 a register of an AGC voltage AGCa of the demodulator DEMODa. A demodulator DEMODb is connected to the CPU 22 and outputs to the CPU 22 a register of an AGC voltage AGCb of the demodulator DEMODb.

Here, the AGC voltage AGCa of the demodulator DEMODa indicates voltage values of AGC voltages RF AGCa and IF AGCa of the demodulator DEMODa, and the AGC voltage AGCb of the demodulator DEMODb indicates voltage values of AGC voltages RF AGCb and IF AGCb of the demodulator DEMODb.

The register here is a value that is obtained by converting a predetermined value that is expressed as a binary data in a binary 10-bit value to a value in a decimal system. Namely, the register of the AGC voltage AGCa of the demodulator DEMODa is value that expresses a combination of the voltage values of the AGC voltages RF AGCa and IF AGCa by the numbers from 0 to 1024 according to the combination of the voltages. Moreover, the register of the AGC voltage AGCb of the demodulator DEMODb is a value that expresses a combination of the voltage values of the AGC voltages RF AGCb and IF AGCb by the numbers from 0 to 1024 according to the combination of the voltages.

The CPU 22 includes an attenuation amount controlling section (voltage comparison control means) 23. The attenuation amount controlling section 23 controls the attenuation amount of the variable attenuator ATT2 based on the registers of the AGC voltages AGCa and AGCb that are inputted form the demodulators DEMODa and DEMODb.

The register of the voltage value of the AGC voltage AGCa is given in accordance with the voltage value of the AGC voltage AGCa, for example, in a manner that the number 0, 1, 2, . . . 1024 in this order is given to each voltage value in a descending order. The register of the voltage value of the AGC voltage AGCb is given in accordance with the voltage value of the AGC voltage AGCb, for example, in a manner that the number 0, 1, 2, . . . 1024 in this order is given to each voltage value in a descending order.

Further, a case where both of the AGC voltages AGCa and AGCb whose registers of the voltage values are in a range from 0 to 100 belongs to a case in a region A of FIG. 2(a). A case where both of the AGC voltages AGCa and AGCb whose registers of the voltage values are in a range from 901 to 1024 belongs to a case in a region D of FIG. 2(a). Further, a case where both of the AGC voltages AGCa and AGCb whose registers of the voltage values are in a range from 101 to 900 belongs to a case in a region B or C (Note that the registers indicating the region B<the registers indicating the region C) of FIG. 2(a).

The register of the voltage value of the AGC voltage AGCa that the demodulator DEMODa outputs and the register of the voltage value of the AGC voltage AGCb that the demodulator DEMODb outputs are inputted into the CPU 22.

When the registers of the AGC voltages AGCa and AGCb are inputted into the CPU 22, the attenuation amount controlling section 23 determines whether or not the registers of the voltage values of the AGC voltages AGCa and AGCb that are inputted into the attenuation amount controlling section 23 is in a predetermined range (threshold value). The attenuation amount controlling section 23 varies, according to the determination result, the voltage that the attenuation amount controlling section 23 supplies to the variable attenuator ATT2. Subsequently, the attenuation amount of the variable attenuator ATT2 is varied.

The predetermined range may be any range as long as an error does not occur in the tuner of the present invention and a trouble does not occur in reception of broadcasts in the range. In other words, an appropriate range can be predetermined as the predetermined range as long as the level of the RF signal that is inputted into the tuner is in a range that belongs to the region B or C.

Here, as described above, a case where both the AGC voltages AGCa and AGCb whose registers of the voltage values are 101 to 900 belongs to a case in the region B or C. Accordingly, here, the predetermined ranges of both of the register of the voltage value of the AGC voltage AGCa and the register of the voltage value of the AGC voltage AGCb are set, for example, in a range from 150 to 850.

That is, in case where at least one of the registers of the voltage values of the AGC voltages AGCa and AGCb that are inputted into the attenuator amount controlling section 23 is out of the predetermined range, the attenuation amount controlling section 23 controls the attenuation amount of the variable attenuator ATT2 so as to have both of the voltage values in the predetermined range.

That is, in case where at least one of the registers of the voltage values of the AGC voltages AGCa and AGCb is less than 150, it is likely that the RF signal that is inputted into the demodulator DEMODa and/or the demodulator DEMODb is small and belongs to the region A of FIG. 2(a). Therefore, the attenuation amount controlling section 23 reduces the attenuation amount of the variable attenuator ATT2.

On the other hand, in case where at least one of the registers of the voltage values of the AGC voltages AGCa and AGCb is more than 850, it is likely that the RF signal that is inputted into the demodulator DEMODa and/or DEMODb is large and belongs to the region D of FIG. 2(a). Therefore, the attenuation amount controlling section 23 increases the attenuation amount of the variable attenuator ATT2.

The RF signal that is attenuated by the variable attenuator ATT2 is amplified by the broadband amplifier AMP1 and outputted to the balun 21.

Here, an arrangement of an attenuator ATT1 and the variable attenuator ATT2 are briefly explained.

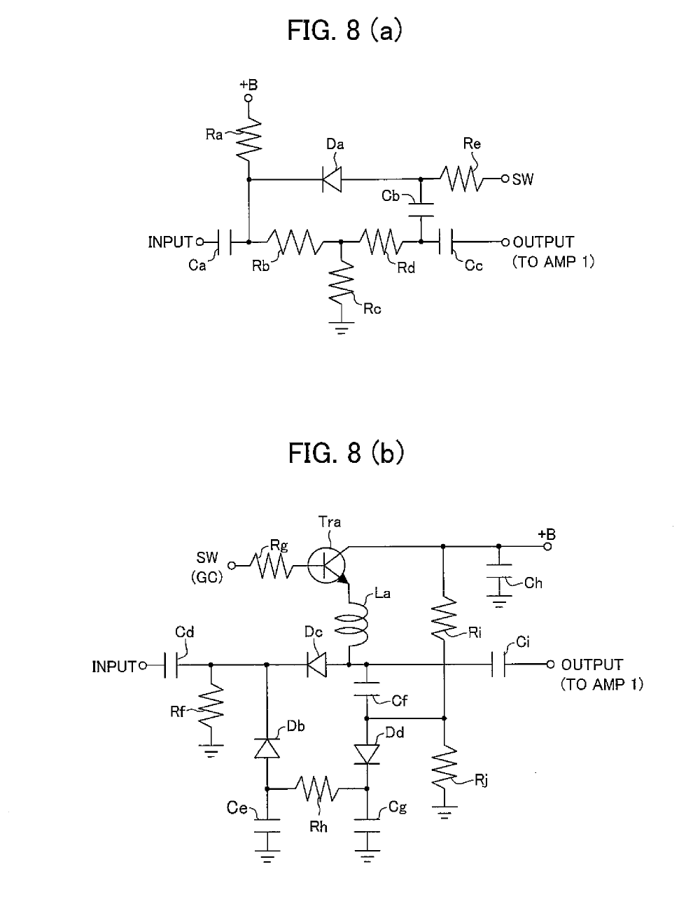

FIG. 8(a) is a diagram illustrating one configuration example of an attenuator that is provided to a tuner of the present invention. FIG. 8(b) is a diagram illustrating one configuration example of an arrangement of a variable attenuator that is provided to the tuner of the present invention.

The attenuator as illustrated in FIG. 8(a) has the following circuit configuration.

That is, a series circuit that is composed of a condenser Ca, resistors Rb and Rd, and a condenser Cc is connected between an input terminal and an output terminal. One end of a resistor Ra is connected to a terminal of the condenser Ca on a side provided with the resistor Rb. The other end of the resister Ra is connected to a terminal +B that is connected to a voltage source. Further, a cathode of a diode Da is also connected to the terminal of the condenser Ca on the side provided with the resistor Rb. An anode of the diode Da is connected to an input terminal SW via a resistor Re. Into the input terminal SW, a voltage that is outputted from the voltage comparator CMP1 is inputted. Further, the anode of the diode Da is connected to one end of a condenser Cb. The other end of the condenser Cb is connected to a terminal of a terminal of the condenser Cc on a side provided with the resistor Rd. One end of a resistor Rc is connected to one end of the resistor Rb on a side provided with the resistor Rd. The other end of the resistor Rc is kept at a ground potential.

The variable attenuator as illustrated in FIG. 8(b) has the following circuit configuration.

That is, a series circuit that is composed of a condenser Cd, a diode Dc and a condenser Ci is connected between an input terminal and an output terminal. A cathode of the diode Dc is connected to the condenser Cd, and an anode of the diode Dc is connected to the condenser Cd. A terminal of the condenser Cd on a side provided with the diode Dc is also connected to one end of a resistor Rf. The other end of the resistor Rf is kept at a ground potential. The cathode of the diode Dc is further connected to a cathode of a diode Db, and an anode of the diode Db is connected to one end of a condenser Ce. The other end of the condenser Ce is kept at a ground potential. The anode of the diode Dc is further connected to one end of an inductance La. The other end of the inductance La is connected to an emitter of the transistor Tra. A base of the transistor Tra is connected to an input terminal SW via the resistor Rg. Into the input terminal SW, a voltage that is outputted from the voltage comparator CMP1 is inputted. A collector of the transistor Tra is connected to the terminal +B to which a voltage source is connected. One end of a condenser Cf is connected to a terminal of the condenser Ci on a side provided with the diode Dc. The other end of the condenser Cf is connected to an anode of a diode Dd. A cathode of the diode Dd is connected to one end of a condenser Cg. The other end of the condenser Cg is kept at a ground potential. Moreover, the cathode of the diode Dd is further connected to one end of a resistor Rh. The other end of the resistor Rh is connected to the anode of the diode Db. One end of a resistor Ri is connected to the collector of the transistor Tra. The other end of the resistor Ri is connected to one end of a resistor Rj. The other end of the resistor Rj is kept at a ground potential. Further, the one end of the resistor RJ is connected to the anode of the diode Dd. One end of a condenser Ch is connected to a terminal +B to which a voltage source is connected. The other end of the condenser Ch is kept at a ground potential.

Each of the circuits as illustrated in FIGS. 8(a) and 8(b) are obtainable with one or a combination of publicly known arrangements. Therefore, explanations of operations and functions of the circuits are omitted here.

This allows the balun 21 to appropriately output an RF signal at a level desirable to the first and second tuner circuits according to reception states of the first and second tuners. The signal that is outputted from the balun 21 is appropriately controlled in terms of a gain by high frequency amplifiers RF AMPa and RF AMPb and intermediate frequency amplifiers IF AMPa and IF AMPb. Then, the levels of the signals that are inputted into the demodulators DEMODa and DEMODb are kept constant.

In the present embodiment, the voltage value of the AGC voltage AGCa of the demodulator DEMODa and the voltage value of the AGC voltage AGCb of the demodulator DEMODb are expressed as registers in binary 10-bit values.

However, an expression method of the AGC voltages AGCa and AGCb is not limited to this. For example, the voltage value of the AGC voltage AGCa of the demodulator DEMODa and the voltage value of the AGC voltage AGCb of the demodulator DEMODb may be expressed in binary 8-bit values.

Further, in the present embodiment, the registers of the voltage values of the AGC voltages AGCa and AGCb are given a number, for example, in a manner that the number 0, 1, 2, . . . 1024 in this order is given to each voltage value in a descending order. However, a relationship between the voltage values of the AGC voltages AGCa and AGCb and the registers that are given to the voltage values is not limited to this. For example, numbers may be given to the registers of the AGC voltages AGCa and AGCb in a manner that the number 0, 1, 2, . . . 1024 in this order is given to each voltage value in an ascending order. In this case, a case where a register of the voltage value is very high belongs a case in the region A of FIG. 2(a). On the other hand, a case where a register of the voltage value is very low belongs to a case in the region D of FIG. 2(a).

Moreover, in the present embodiment, the predetermined range of the AGC voltage AGCa is set to be the same as the predetermined range of the AGC voltage AGCb. However, the predetermined range is not limited to this. The predetermined range of the AGC voltage AGCa may be set to be different from the predetermined range of the AGC voltage AGCb.

Further, in the present embodiment, the attenuation amount controlling section 23 controls the attenuation amount of the variable attenuator ATT2 with the use of the AGO voltages AGCa and AGCb.

However, a method with which the attenuation amount controlling section 23 controls the attenuation amount of the variable attenuator ATT2 is not limited to this. Example of the method other than the above method is as follows.

That is, in case where an error occurs in the demodulators (error transmission means) DEMODa and DEMODb, the demodulators (error transmission means) DEMODa and DEMODb outputs to the CPU 22 an error flag indicating the error. Then, the attenuation amount controlling section (error flag comparison controlling means) 23 sets a value of the attenuation amount of the variable attenuator ATT2 according the error flag so that the error that occurs in the demodulators DEMODa and DEMODb become minimum. The attenuation amount of the variable attenuator ATT2 may be controlled in this way.

The control of the variable attenuator ATT2 by the CPU 22 may be performed at any timing. However, the control is preferably performed as a routine every time a broadcast is selected, that is, a receive channel is changed. This makes it possible to supply a signal at a desired level to the first and second tuner circuits when the receive channel of a receiver is changed.

In this way, it becomes possible to control a level of a signal that is outputted and distributed by the balun 21 to a level desirable to that the first and second tuner circuits, according to variation in the levels of the signals that are inputted into the demodulators DEMODa and DEMODb.

Moreover, the input terminal 1in of the tuner 13 is connected to the receiver in a state without wiring and a distributor is included in the tuner 13, the number of coaxial cables can be reduced.

Accordingly, cost increase due to the use of a plurality of coaxial cables can be suppressed and material cost and man-hour can be reduced.

Further, the present embodiment may be combined with the embodiment that is illustrated in FIG. 3 and explained above.

That is, the present embodiment includes an arrangement in which the variable attenuator ATT2 is provided between the input terminal tin and the balun 21 and the attenuation amount controlling section 23 of the CPU 22 adjusts the attenuation amount of the variable attenuator ATT2 so that the registers of the voltage values of the AGC voltages AGCa and AGCb are in the predetermined range.

However, the arrangement to control, by the attenuation amount controlling section 23 of the CPU 22, the level of the RF signal that is inputted into the balun 21 is not limited to this. For example, a parallel circuit that is composed of an attenuator ATT1 and a switch SW1 may be provided in lieu of the variable attenuator ATT2 in the arrangement of the tuner 13 as illustrated in FIG. 7. Further, the attenuation amount controlling section 23 may control switching of the switch SW1 so that the registers of the voltage values of the AGC voltages ACCa and AGCb are in the predetermined range.

### Embodiment 5

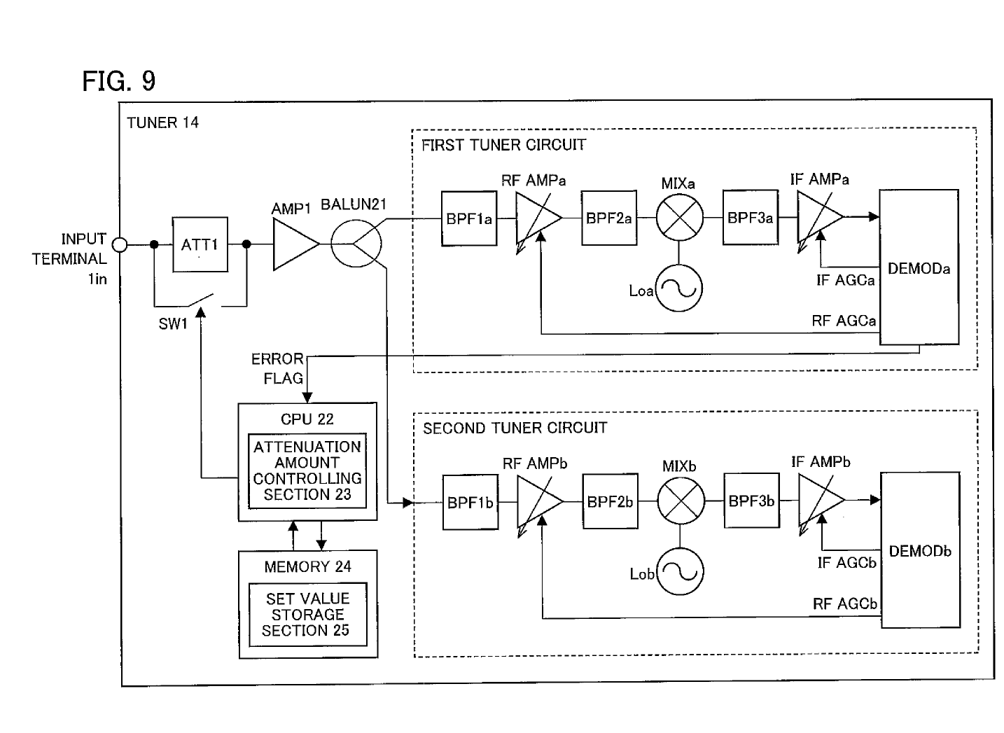

FIG. 9 is a circuit block diagram of another tuner of the present invention.

In a tuner 14 as illustrated in FIG. 9, a parallel circuit that is composed of an attenuator ATT1 and a switch SW1 is provided in lieu of a variable attenuator ATT2 in an arrangement of a tuner 13 as illustrated in FIG. 7.

The tuner 14 as illustrated in FIG. 9 includes a memory (voltage comparison control means) 24 including a set value storage section 25. The memory 24 is connected to a CPU 22. In the set value storage section 25, a set value for setting a preferable switching state of the switch SW1 in a case where a receiver receives a predetermined channel is stored in advance for each of a plurality of receive channels that the receiver receives.

Further, the attenuation amount control section 23 controls switching of the switch SW1 based on the set value that the set value storage section 25 stores.

An output level of a balun 21 is the same for the first and second tuner circuit. Accordingly, when an initial receive channel setting is performed with respect to the receiver in which the tuner 14 is provided, only an operation of the first tuner circuit at the time of inputting the RF signal into the first tuner circuit is examined in advance for each receive channel. Then, the set value that minimize an error that occurs in the demodulator DEMODa is stored in the set value storage section 25 in advance for each receive channel. Based on the set value, switching of the switch SW1 is controlled.

This allows the CPU 22 to read the set value of the switching of the switch SW1 which set value is stored in the set value storage section 25 in advance and minimizes the error and to control the switch SW1 according to the set value, even when the first and second tuner circuits receive different receive channels, respectively. This makes it possible to minimize an error that occurs in the demodulators DEMODa and DEMODb.

In other words, for example, a case where channels 1 through 6 are set in the receiver is considered. In this case, for example, the following method is applicable to set the set value.

That is, in case where the first tuner circuit receives each of the channels 1 through 6, the CPU 22 counts the number of times of errors in a case where the switch SW1 is opened and the number of times of errors in a case where the switch SW1 is closed. The counting by the CPU22 is performed, for example, by counting the number of times for which the error flags outputted from the demodulator DEMODa is inputted.

As a result of counting the number of errors that occur in the demodulator DEMODa for each receive channel of the first tuner circuit and for each switching of the switch SW1, a result as shown in Table 4 is obtained.

TABLE 4

| | INPUTTED | SW1 CLOSE | SW1 OPEN |
|---|---|---|---|
| | RF | (ATTENUATION | (ATTENUATION |
| | SIGNAL | AMOUNT: | AMOUNT: |
| | LEVEL | SMALL) | LARGE) |
| CHANNEL 1 | Intermediate | 0 | 0 |
| CHANNEL 2 | Large | 0 | 5 |
| CHANNEL 3 | Intermediate | 0 | 0 |
| CHANNEL 4 | Small | 10 | 0 |
| CHANNEL 5 | Intermediate | 0 | 0 |
| CHANNEL 6 | Large | 0 | 3 |

Note that each of the numbers shown in Table 4 above indicates the number of times of errors in a case where the first tuner circuit receives a predetermined channel and the switch SW1 is in a predetermined state. That is, the number “10” in the “channel 4” line and the “SW1 CLOSE (ATTENUATION AMOUNT: SMALL)” column means that “ten errors occurred in the demodulator DEMODa in a state where the first tuner circuit is receiving the channel 4 and the switch SW1 is closed”.

Table 5 below shows each set value that is set for each receive channel based on the result of the Table 4 above.

TABLE 5

| | | SECOND TUNER CIRCUIT | | | | | |
|---|---|---|---|---|---|---|---|
| | | CHANNEL 1 | CHANNEL 2 | CHANNEL 3 | CHANNEL 4 | CHANNEL 5 | CHANNEL 6 |
| FIRST | CHANNEL 1 | OPEN (0) | CLOSE (0) | OPEN (0) | OPEN (0) | OPEN (0) | CLOSE (0) |
| TUNER | CHANNEL 2 | CLOSE (0) | CLOSE (0) | CLOSE (0) | OPEN (5) | CLOSE (0) | CLOSE (0) |
| CIRCUIT | CHANNEL 3 | OPEN (0) | CLOSE (0) | OPEN (0) | OPEN (0) | OPEN (0) | CLOSE (0) |
| | CHANNEL 4 | OPEN (0) | OPEN (5) | OPEN (0) | OPEN (0) | OPEN (0) | OPEN (3) |
| | CHANNEL 5 | OPEN (0) | CLOSE (0) | OPEN (0) | OPEN (0) | OPEN (0) | CLOSE (0) |
| | CHANNEL 6 | CLOSE (0) | CLOSE (0) | CLOSE (0) | OPEN (3) | CLOSE (0) | CLOSE (0) |

In the Table 5 above, the number in the parentheses that is provided on the right with respect to “CLOSE” or “OPEN” indicates the number of errors that occur in the demodulator DEMODa in a case where the switching state of the switch SW1 is set “CLOSE” or “OPEN”.

For example, the following explains a method of setting the set values by using as an example a case where the first tuner circuit receives the channel 2 and the second tuner circuit receives the channel 4.

In the Table 4 above, the number of times of errors at reception of the channel 2 is “0”, in a state where the switch SW1 is closed and “5” in a state where the switch SW1 is open. The number of times of errors at reception of the channel 4 is “10” in a state where the switch SW1 is closed and “0” in a state where the switch SW1 is open.

Accordingly, in this case, the set value should be set to a value indicative of a state of switching of the switch SW1 which state causes less errors, that is, the state where the switch SW1 is open (error number “5”) (Note that the error number is “10” in the state where the switch SW1 is closed).

The set value that is set as in the Table 5 for each receive channel is stored in the set value storage section 25.

Then, when a predetermined receive channel is received, the attenuation amount controlling section 23 of the CPU 22 controls a switching state of the switch SW1 according to the set value of the switch SW1 for the receive channel which set value is stored in the set value recording section 25.

This allows the CPU 22 to read the set value of the switching of the state SW1 which set value is stored in the set value storage section 25 and minimizes the error and to control the switch SW1 according to the set value, even when the first and second tuner circuits receive separate receive channels, respectively. This makes it possible to minimize an error that occurs in the demodulators DEMODa and DEMODb.

Moreover, an input terminal 1in of the tuner 14 is connected to the receiver in a state without wiring and a distributor is further included in the tuner 14. This makes it possible to reduce the number of coaxial cables.

Accordingly, cost increase due to the use of a plurality of coaxial cables can be suppressed and material cost and man-hour can be reduced.

Further, the present embodiment may be combined with the embodiment as illustrated in FIG. 7 explained above.

That is, the present embodiment includes an arrangement in which a parallel circuit that is composed of the attenuator ATT1 and the switch SW1 is provided between the input terminal tin and the balun 21. Moreover, the attenuation amount controlling section 23 of the CPU 22 controls the level of the RF signal that is to be inputted into the balun 21 by controlling the switching of the switch SW 1 according to the set value that is stored in the set value storage section 25 of the memory 24.

However, the arrangement to control, by the attenuation amount controlling section 23 of the CPU 22, the level of the RF signal that is to be inputted into the balun 21 is not limited to this. For example, the variable attenuator ATT2 may be provided in lieu of a parallel circuit that is composed of an attenuator ATT1 and a switch SW1 in the arrangement of the tuner 14 as illustrated in FIG. 9.

Here, a brief explanation is given on a method of controlling an attenuation amount of the variable attenuator ATT2 in the case of an arrangement that combines the present embodiment and the embodiment as illustrated in FIG. 7, that is, an arrangement in which a variable attenuator ATT2 is provided in lieu of the parallel circuit composed of the attenuator ATT1 and the switch SW1 in an arrangement of the tuner 14 as illustrated in FIG. 9.

In case where a receiver receives a plurality of channels, the first tuner circuit receives each of the channels. In such a case, the number of times of errors in a case where the set value of the attenuation amount of the variable attenuator ATT2 is a predetermined value is counted, for example, by counting the number of times for which error flags that the demodulator DEMODa outputs are inputted. This counting operation is performed for each of a plurality of set values of attenuation amounts of the variable attenuator ATT2. Then, based on the counting result of concerning the plurality of the set values of the attenuation amounts, the set values of the attenuation amounts of the variable attenuator ATT2 are set for each receive channel.

The following Tables 6 and 7 shows the counting result of the counting operation and an example of setting the attenuation amount of the variable attenuator ATT2 in a case where the level of the RF signal that is to be inputted into the balun 21 is controlled by using the variable attenuator ATT2.

TABLE 6

| | | ATTENUATION | ATTENUATION |
|---|---|---|---|
| | INPUTTED | AMOUNT 5 dB | AMOUNT 10 dB |
| | RF | (ATTENUATION | (ATTENUATION |
| | SIGNAL | AMOUNT: | AMOUNT: |
| | LEVEL | SMALL) | LARGE) |
| CHANNEL 1 | Intermediate | 0 | 0 |
| CHANNEL 2 | Large | 0 | 5 |
| CHANNEL 3 | Intermediate | 0 | 0 |
| CHANNEL 4 | Small | 10 | 0 |
| CHANNEL 5 | Intermediate | 0 | 0 |
| CHANNEL 6 | Large | 0 | 3 |

TABLE 7

| | | SECOND TUNER CIRCUIT | | | | | |
|---|---|---|---|---|---|---|---|
| | | CHANNEL 1 | CHANNEL 2 | CHANNEL 3 | CHANNEL 4 | CHANNEL 5 | CHANNEL 6 |
| FIRST | CHANNEL 1 | 10 dB (0) | 5 dB (0) | 10 dB (0) | 10 dB (0) | 10 dB (0) | 5 dB (0) |
| TUNER | CHANNEL 2 | 5 dB (0) | 5 dB (0) | 5 dB (0) | 10 dB (5) | 5 dB (0) | 5 dB (0) |
| CIRCUIT | CHANNEL 3 | 10 dB (0) | 5 dB (0) | 10 dB (0) | 10 dB (0) | 10 dB (0) | 5 dB (0) |
| | CHANNEL 4 | 10 dB (0) | 10 dB (5) | 10 dB (0) | 10 dB (0) | 10 dB (0) | 10 dB (3) |
| | CHANNEL 5 | 10 dB (0) | 5 dB (0) | 10 dB (0) | 10 dB (0) | 10 dB (0) | 5 dB (0) |
| | CHANNEL 6 | 5 dB (0) | 5 dB (0) | 5 dB (0) | 10 dB (3) | 5 dB (0) | 5 dB (0) |

In Table 7 above, the number in the parentheses provided on the right with respect to the “5 dB” or “10 dB” is the number of errors that occur in the demodulator DEMODa at the time when the switching state of the switch SW1 is set to “5 dB” or “10 dB”.

As shown in Table 6, the counting operation may be performed in a case where the set value of the attenuation amount of the variable attenuator ATT2 is 5 db and in a case where the set value of the attenuation amount of the variable attenuator ATT2 is 10 dB. However, the set value of the attenuation amount of the variable attenuator ATT2 in the counting operation is not limited to 5 dB and 10 dB. The set value may be set as appropriate according to the attenuation amount or the like that the variable attenuation amount ATT2 varies.

Further, as shown in Table 7, the set value of the attenuation amount of the variable attenuator ATT2 may be set to a set value of an attenuation amount that causes the smaller number of errors.

For example, when the first tuner circuit receives the channel 2 and the second tuner circuit receives the channel 4, according to the Table 6 above, the number of times of errors at the channel 2 is “0” in a state where the set value of the attenuation amount is 5 dB and “5” in a state where the set value of the attenuation amount is 10 dB. Moreover, the number of times of errors at the channel 4 is “10” in a state where the set value of the attenuation amount is 5 dB and “0” in a state where the set value of the attenuation amount is 10 dB.

Accordingly, in this case, the set value of the attenuation amount of the variable attenuator ATT2 should be set to the set value in the state where the attenuation amount is 10 dB at which the smaller number of errors occur.

Then, the set value of the attenuation amount of the variable attenuator ATT2 for each receive channel which set value is set as shown in Table 7 above is stored in the set value storage section 25.

Then, when a predetermined receive channel is received, the attenuation amount controlling section 23 of the CPU 22 controls the switching state of the switch SW1 based on the set value of the attenuation amount of the variable attenuator ATT2 which set value is stored in the set value storage section 25 and corresponds to the set value at the receive channel.

In the present embodiment, the number of errors that occur in the first tuner circuit is counted and the switch SW1 is controlled according to the counting result (or the attenuation amount is varied). However, a method of controlling the switch SW1 is not limited to this. The number of errors that occur in the second tuner circuit may be counted and the switch SW1 may be controlled (or the attenuation amount is controlled) according to a result of the counting.

In the present embodiment, the number of errors that occur in the tuner circuit is counted for each receive channel and for each switching of the switch SW1, and the set value that is set according to a result of the counting is stored in the memory 24. However, the present invention is not limited to this.

That is, for example, an AGC voltage (at least one among AGC voltages RF AGCa, RF AGCb, IF AGCa, and IF AGCb) that is outputted from the demodulator DEMOD (namely, the demodulator DEMODa or DEMODb) is inputted into the CPU 22. A voltage value of the AGC voltage may be checked for each receive channel and for each switching of the switch SW1. The set value that is set according to a result of the check may be stored in the memory 24.

Each processing in the CPU 22 of the embodiment as illustrated in FIG. 7 and the present embodiment may be realized by executing a program that causes a computer to perform the processing and that can be stored in a storage medium such as a CD-ROM or the like. The program and the storage medium are also included in the scope of the present invention.

Moreover, in the present embodiment, the error flag may be changed to a register (refer to the embodiment as illustrated in FIG. 7) indicative of a voltage value of a control voltage.

The present embodiment and the embodiments above explain a case where the tuner includes two tuner circuits. The present invention is not limited to this. In the tuner of the present invention, not less than three tuner circuits may be provided. The number of tuner circuits that are provided in the tuner of the present invention should be determined as appropriate in consideration of the number of receive channels that the receiver including the tuner of the present invention should concurrently receive, or the like.

The control of the switch SW1 (or the variable attenuator ATT2) by the CPU 22 may be performed at any timing. However, the control is preferably performed once as a routine every time a broadcast is selected, that is, a receive channel is changed. This makes it possible to supply a signal at a desired level to the first and second tuner circuits when the receive channel of the receiver is changed.

The tuner of the present invention can be preferably used as a receiver device in an apparatus including a function to concurrently receive a plurality of broadcasts. An example of the apparatus including the function to concurrently receive a plurality of broadcasts is a multi-screen display apparatus (an apparatus capable of concurrently showing a plurality of broadcasts or broadcast and video image of a DVD that is connected to a video image input terminal) and a dual video signal simultaneous recording apparatus (an apparatus in which normal HDD recording or recording by back recording (recording by using a region different from a region used in the normal HDD recording) may be selected at recording reservation of a program to be recorded and, when recording reservations of programs overlap, both programs can be recorded by switching one to recording by back recording). Further, specific examples of such an apparatus are a television receiver and a DVD recorder.

In order to solve the problem mentioned above, a signal distribution device of the present invention including a distributor that outputs to distribute a signal inputted into the distributor into a plurality of circuits, the signal distribution device includes: an amplifier amplifying a level of a signal to be inputted into the distributor; switching circuit (switching means) switching between a first state and a second state, the level of the signal inputted into the distributor in the first state being a different value from a value of the level of the signal inputted into the distributor in the second state; and voltage comparison control circuit (voltage comparison control means) controlling switching by the switching circuit according to a voltage value of a control voltage inputted into the voltage comparison control circuit.

According to the arrangement, the signal distribution device of the present invention includes an amplifier, switching circuit, and voltage comparison control circuit. The amplifier amplifies a signal inputted into the amplifier and outputs the amplified signal to the distributor. Moreover, the switching circuit switches between the first state and the second state. Further, the voltage comparison control circuit controls the switching circuit according to the control voltage inputted into the voltage comparison control circuit.

In case where the signal inputted into the distributor is kept at a constant level as in a conventional arrangement, the level of the signal may vary due to various signal processes preformed in the circuit into which the signal outputted from the distributor has been inputted. The variation in the level of the signal makes it impossible to supply a signal having a level desirable to the circuit.

On the other hand, in the signal distribution device of the present invention, the voltage comparison control circuit controls, in accordance with a control voltage, the switching circuit that varies the level of the signal, thereby allowing the level of the signal inputted into the distributor to be varied. This makes it possible to reliably supply the signal at the level desirable to the circuit by setting the control voltage to an appropriate value, even in case where the variation in the level of the signal occurs.

Accordingly, it becomes possible to control the level of the signal that the distributor outputs.

In the signal distribution device of the present invention: in the first state of the switching circuit, the signal to be inputted into the distributor passes through the amplifier and then is inputted into the distributor; and in the second state of the switching circuit, the signal to be inputted into the distributor does not pass through the amplifier but is directly inputted into the distributor.

According to the arrangement, in the first state of the switching circuit, the signal inputted into the distributor is inputted into the distributor after passing through the amplifier. On the other hand, in the second state of the switching circuit, the signal inputted into the distributor does not pass through the amplifier before inputted into the distributor. Namely, in the first state of the switching circuit, the signal inputted into the distributor is amplified. On the other hand, in the second state of the switching circuit, the signal inputted into the distributor is not amplified. In this way, with the use of the switching circuit, the level of the signal inputted into the distributor can be varied.

The signal distribution device of the present invention further includes: an attenuator being provided in a preceding stage of the amplifier and attenuating a level of a signal to be inputted into the amplifier, in the first state of the switching circuit, the signal to be inputted into the amplifier passing through the attenuator and then being inputted into the amplifier, and in the second state of the switching circuit, the signal to be inputted into the amplifier which signal does not pass through the amplifier being directly inputted into the amplifier.

According to the arrangement, the signal distribution device further includes an attenuator that is provided in a preceding stage of the amplifier and attenuates the level of the signal to be inputted into the amplifier.

If a signal inputted into the amplifier is at a large level and the signal at the large level is amplified, distortion occurs in the amplifier. This may deteriorate a BER of the signal outputted from the amplifier. In order to solve this problem, the attenuator is provided in the preceding stage of the amplifier. After the level of the signal is attenuated by this attenuator, the signal is inputted into the amplifier. This reduces a risk that a signal at a large level is inputted into the plurality of circuits.

Moreover, in the first state of the switching circuit, the signal to be inputted into the amplifier is inputted into the distributor after passing through the attenuator. On the other hand, in the second state of the switching circuit, the signal to be inputted into the amplifier does not pass through the attenuator before inputted into the amplifier. Namely, in the first state of the switching circuit, the signal to be inputted into the amplifier is attenuated by the attenuator in the preceding stage. On the other hand, in the second state of the switching circuit, the signal to be inputted into the amplifier is not attenuated. In this way, with the use of the switching circuit, the level of the signal to be inputted into the amplifier can be varied.

In the signal distribution device of the present invention: the amplifier includes a first amplifier and a second amplifier which have gains different from each other; in the first state of the switching circuit, the signal to be inputted into the distributor passes through the first amplifier and then is inputted into the distributor; and in the second state of the switching circuit, a signal to be inputted into the distributor passes through the second amplifier and then is inputted into the distributor.

According to the arrangement, the amplifier includes the first and second amplifiers. The first and second amplifiers are made of amplifiers having gain characteristics different from each other. In the first state of the switching circuit, the signal to be inputted into the distributor is inputted into the distributor after passing through the first amplifier. On the other hand, in the second state of the switching circuit, the signal to be inputted into the distributor is inputted into the distributor after passing through the second amplifier. Namely, in the first state of the switching circuit, the signal to be inputted into the distributor is amplified by the first amplifier. On the other hand, in the second state of the switching circuit, the signal to be inputted into the distributor is amplified by the second amplifier having a different gain from a gain of the first amplifier. This allows the switching circuit to vary the level of the signal to be inputted into the distributor.

In the signal distribution device of the present invention: the amplifier is a variable amplifier whose gain is variable; the voltage comparison control circuit controls a gain of the amplifier by applying a gain control voltage varying, according to a voltage value, the gain of the amplifier to a predetermined terminal of the amplifier; in the first state of the switching circuit, the voltage comparison control circuit and the predetermined terminal of the amplifier are electrically connected; and in the second state of the switching circuit, the voltage comparison control circuit and the predetermined terminal of the amplifier are not electrically connected.

According to the arrangement, the amplifier is a variable amplifier whose gain is variable. Moreover, the voltage comparison control circuit controls the gain of the amplifier by applying a gain control voltage varying, according to the voltage value, the gain of the amplifier to a predetermined circuit of the amplifier, thereby controlling the gain of the amplifier. In the first state of the switching circuit, the voltage comparison control circuit and a predetermined terminal of the amplifier are electrically connected. On the other hand, in the second state of the switching circuit, the voltage comparison control circuit and a predetermined terminal of the amplifier are not electrically connected. This allows the switching circuit to vary the level of the signal to be inputted into the distributor.

The following arrangements may be employed as arrangement capable of controlling the level of the signal as mentioned above.

That is, the signal distribution device of the present invention may be arranged such that the amplifier includes a transistor; and in the first state of the switching circuit, the voltage comparison control circuit applies the gain control voltage to a base of the transistor via the predetermined terminal of the amplifier so as to control the gain of the amplifier. The signal distribution device of the present invention may also be arranged such that the amplifier includes a transistor; and in the first state of the switching circuit, the voltage comparison control circuit applies the gain control voltage to an emitter of the transistor via the predetermined terminal of the amplifier so as to control the gain of the amplifier. Further, the signal distribution device of the present invention may also be arranged such that the amplifier includes a transistor and a feedback circuit that inputs a part of an output from a collector of the transistor into a base of the transistor; and in the first state of the switching circuit, the voltage comparison control circuit varies an impedance of the feedback circuit by applying the gain control voltage to the feedback circuit via the predetermined terminal of the amplifier, so as to control the gain of the amplifier by variation in the impedance. Furthermore, the signal distribution device of the present invention may also be arranged such that the amplifier includes a transistor and one or both of a condenser and a variable capacitor diode that are provided between an emitter of the transistor and a ground plane of the transistor; and n the first state of the switching circuit, the voltage comparison control circuit varies a capacitance of one or both of the condenser and the variable capacitor diode by applying the gain control voltage to one or both of the condenser and the variable capacitor diode via the predetermined terminal of the amplifier, so as to control the gain of the amplifier by variation in the capacitance.

Accordingly, control of the level of the signal outputted from the distributor becomes possible. Moreover, because the control is performed by appropriately varying the gain of the amplifier, the control can be performed more precisely.

In the signal distribution device of the present invention: the voltage comparison control circuit controls switching between the first state and the second state of the switching circuit, based on a comparison result of comparing the voltage value of the control voltage inputted into the voltage comparison control circuit and a predetermined threshold value.

According to the arrangement, the voltage comparison control circuit controls switching between the first state and the second state of the switching circuit, based on a comparison result of comparing the voltage value of the control voltage inputted into the voltage comparison control circuit and a predetermined threshold voltage value.

In the signal distribution device of the present invention: the voltage comparison control circuit stores in advance information for controlling switching of the switching circuit according to a frequency band of a signal inputted into the signal distribution device.

According to the arrangement, the voltage comparison control circuit stores in advance information to control switching of the switching circuit according to a frequency band of a signal inputted into the signal distribution device. For example, in case where the signal distribution device of the present invention is provided in a television receiver, setting of the switching circuit for each receive channel of the television receiver (setting of whether to have the switching circuit in the first state or the second state in a predetermined receive channel) can be stored in advance. Subsequently, in case where the television receiver receives the predetermined receive channel in practice, the switching of the switching circuit can be automatically controlled by reading the setting of the switching circuit.

In the signal distribution device of the present invention, it is preferable that the voltage comparison control circuit perform switching control of the switching circuit once every time a frequency band of a signal inputted into the signal distribution device varies.

In order to solve the problem mentioned above, a signal distribution device of the present invention including a distributor that outputs to distribute a signal inputted into the distributor into a plurality of circuits, the signal distribution device includes: an amplifier amplifying a level of a signal to be inputted into the distributor; a variable attenuator attenuating a level of a signal to be inputted into the amplifier and having a variable attenuation amount; and voltage comparison control circuit (voltage comparison control means) controlling the attenuation amount of the variable attenuator according to a voltage value of a control voltage inputted into the voltage comparison control circuit, the voltage value of the control voltage inputted into the voltage comparison control circuit being a register expressing a binary ten-digit value as a value in a decimal system which binary ten-digit value is determined according to a level of the voltage value, and the voltage comparison control circuit controlling variation in the attenuation amount of the attenuator based on a comparison result of comparing the register of the voltage value of the control voltage inputted into the voltage comparison control circuit and a predetermined threshold value of the register.

According to the arrangement, the signal distribution device of the present invention includes an amplifier, a variable attenuator, and voltage comparison control circuit. The amplifier amplifies the signal inputted into the amplifier and outputs the signal to the distributor. The variable attenuate, whose attenuation amount is variable, attenuates the signal inputted into the variable attenuator and outputs the signal to the amplifier. Further, the voltage comparison control circuit controls the attenuation amount of the variable attenuator according to the control voltage inputted into the voltage comparison control circuit. The voltage value of the control voltage inputted into the voltage comparison control circuit is a register. The voltage comparison control circuit controls variation in the attenuation amount of the variable attenuator, based on a comparison result of comparing the register of the voltage value of the control voltage inputted into the voltage comparison control circuit and a predetermined register. In the present application, the “register” is a value that expresses, as a value in a decimal system, a binary ten-digit value determined according to the level of the voltage.

In case where the signal inputted into the distributor is kept at a constant level as in a conventional arrangement, the level of the signal may vary due to various signal processes performed in the circuit into which the signal outputted from the distributor has been inputted.

On the other hand, in the signal distribution device of the present invention, the voltage comparison control circuit controls the switching circuit that varies the level of the signal, based on a comparison result of comparing a voltage value of a control voltage inputted as a register and a predetermined threshold value of the register of the voltage value. This allows varying the level of the signal to be inputted into the distributor.

Accordingly, the level of the signal that is outputted from the distributor can be controlled. Moreover, because the control is performed by appropriately varying the attenuation amount of the variable attenuator, the control can be performed more precisely.

In the signal distribution device of the present invention: the voltage comparison control circuit stores in advance information for controlling the attenuation amount of the variable attenuator according to a frequency band of a signal inputted into the signal distribution device.

According to the arrangement, the voltage comparison control circuit stores in advance information to control the attenuation amount of the variable attenuator according to a frequency band of a signal inputted into the signal distribution device. For example, in case where the signal distribution device of the present invention is provided in a television receiver, a set value of the attenuation amount of the variable attenuator for each receive channel of the television receiver can be stored in advance. Subsequently, in case where the television receiver receives a predetermined receive channel in practice, the attenuation amount of the variable attenuator can be automatically controlled by reading the set value of the attenuation amount of the variable attenuator.

In the signal distribution device of the present invention, it is preferable that: the voltage comparison control circuit perform control of the attenuation amount of the variable attenuator once every time a frequency band of a signal inputted into the signal distribution device varies.

Moreover, in the signal distribution device of the present invention: a control voltage to be inputted into the voltage comparison control circuit is outputted from at least one of the plurality of circuits.

According to the arrangement, the control voltage inputted into the voltage comparison control circuit is outputted from at least one of the plurality of circuits into which the distributor outputs to distribute the signal. This allows the signal distribution device to control the level of the signal, that the distributor outputs, according to a circuit state of the circuit into which the distributor inputs the signal.

In order to solve the problem mentioned above, a signal distribution device of the present invention including a distributor that outputs to distribute a signal inputted into the distributor into a plurality of circuits, the signal distribution device includes: an amplifier amplifying a level of a signal to be inputted into the distributor; a variable attenuator attenuating a level of a signal to be inputted into the amplifier and having a variable attenuation amount; error transmission circuit (error transmission means) transmitting an error flag in case where an error occurs; and error flag comparison control circuit (error flag comparison control means), into which the error flag outputted from the error transmission circuit is inputted, controlling the attenuation amount of the variable attenuator according to a number of times for which the error flag is inputted.

According to the arrangement, the signal distribution device of the present invention includes an amplifier, a variable attenuator, error transmission circuit, and error flag comparison control circuit. The amplifier amplifies the signal inputted into the amplifier and outputs the signal to the distributor. The variable attenuator whose attenuation amount is variable attenuates the signal inputted into the variable attenuator and outputs the signal to the amplifier. Moreover, the error flag comparison control circuit receives an error flag outputted from the error transmission circuit and controls the attenuation amount of the variable attenuator according to the number of times for which the error flag is inputted.

In case where the signal inputted into the distributor is kept at a constant level as in a conventional arrangement, the level of the signal may vary due to various signal processes performed in the circuit into which the signal outputted from the distributor has been inputted.

On the other hand, in the signal distribution device of the present invention, the error flag comparison control circuit controls the level of the signal according to the number of times for which the error flag is inputted, thereby varying the level of the signal to be inputted into the distributor.

Accordingly, the level of the signal outputted from the distributor can be controlled. Moreover, because the control is performed by appropriately varying a gain of the variable amplifier, the level of the signal can be more precisely controlled.

In the signal distribution device of the present invention, it is preferable that the error flag comparison control circuit store in advance information for controlling the attenuation amount of the variable attenuator according to a frequency band of a signal inputted into the signal distribution device. Moreover, it is preferable that an error flag to be inputted into the error flag comparison control circuit be outputted from at least one of the plurality of circuits. Furthermore, it is preferable that the error flag comparison control circuit perform control of the attenuation amount of the variable attenuator once every time a frequency band of a signal inputted into the signal distribution device varies.

In order to solve the problem mentioned above, a receiver device provided in an apparatus capable of concurrently receiving a plurality of signals whose frequencies are different, the receiver device includes: any one of the distribution devices above, the plurality of circuits being a plurality of receiver circuits that are connected to output terminals of the distributor of the signal distribution device, respectively, and capable of concurrently receiving signals whose frequency bands are different from each other.

According to the arrangement, the receiver device of the present invention includes one of the signal distribution devices above. Moreover, the receiver device of the present invention includes, as the plurality of circuits, a plurality of receiver circuits that are connected to output terminals of the distributor of the signal distribution device, respectively, and capable of concurrently receiving signals having different frequencies from each other.

This allows controlling the level of the signal that the distributor outputs to the plurality of receiver circuits.

Moreover, the receiver device of the present invention includes the plurality of receiver circuits and the distributor in the receiver device. This makes it possible to reduce the number of coaxial cables for connection.

Accordingly, it becomes possible to suppress cost increase due to the use of the plurality of coaxial cables and to reduce material cost and man-hour.

In the receiver device of the present invention: each of the plurality of receiver circuits includes: a demodulator demodulating a signal inputted; and a variable gain amplifier, that is provided in a subsequent stage of the distributor and a preceding stage of the demodulator, amplifying the signal inputted and varying a gain according to a power consumption of the variable gain amplifier, the demodulator varies the gain of the variable gain amplifier according to a level of the signal to be demodulated, by providing the control voltage to the variable gain amplifier, and also outputs the control voltage to the voltage comparison control circuit of the signal distribution control circuit.

According to the arrangement above, each of the plurality of receiver circuits includes a demodulator demodulating the signal inputted and a variable gain amplifier that is provided in a subsequent stage of the distributor and in a preceding stage of the demodulator. The variable gain amplifier amplifies the signal inputted and varies a gain according to a consumption power of the variable gain amplifier. The demodulator varies the gain of the variable gain amplifier by providing the control voltage to the variable gain amplifier according to the level of the signal to be demodulated, and outputs the control voltage to the voltage comparison control circuit of the signal distribution device. This allows the signal distribution device to control, according to the variation in the level of the signal inputted into the demodulator, the level of the signal that the distributor inputs into the receiver circuit.

In the receiver device of the present invention, it is preferable that the variable gain amplifier amplify one or both of a level of a radio frequency signal and a level of an intermediate frequency signal.

Moreover, in the receiver device of the present invention, each of the plurality of receiver circuits may include a demodulator demodulating an inputted signal, the demodulator serving as the error transmission circuit.

According to the arrangement, each of the plurality of receiver circuit includes a demodulator demodulating the input signal. The demodulator serves as error transmission circuit.

An apparatus of the present invention, in order to solve the problem mentioned above, is an apparatus capable of concurrently receiving a plurality of signals whose frequencies are different from each other, and includes any one of the receiver devices above.

According to the arrangement, the apparatus of the present invention includes any one of the receiver devices mentioned above.

Accordingly, it becomes possible to control the level of the signal that the distributor of the signal distribution device outputs to the plurality of receiver circuits.

Further, an input terminal of the receiver device can be connected to the apparatus in a state without wiring. Furthermore, the plurality of receiver circuits and the distributor are included in the receiver device. This makes it possible to reduce the number of coaxial cables.

Accordingly, cost increase due to the use of the plurality of coaxial cables can be suppressed and material cost and man-hour can be reduced.

The present invention is preferably applied to a receiver device in an apparatus that has a function of concurrently receiving a plurality of broadcasts, and further to an apparatus including the receiver device, for example, a television receiver or a DVD recorder.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A signal distribution device including a distributor that outputs to distribute a signal inputted into the distributor into a plurality of circuits, the signal distribution device comprising:
an amplifier amplifying a level of a signal to be inputted into the distributor;
switching means switching between a first state and a second state, the level of the signal inputted into the distributor in the first state being a different value from a value of the level of the signal inputted into the distributor in the second state; and
voltage comparison control means controlling switching by the switching means according to a voltage value of a control voltage inputted into the voltage comparison control means.

2. The signal distribution device as set forth in claim 1, wherein:
in the first state of the switching means, the signal to be inputted into the distributor passes through the amplifier and then is inputted into the distributor; and
in the second state of the switching means, the signal to be inputted into the distributor does not pass through the amplifier but is directly inputted into the distributor.

3. The signal distribution device as set forth in claim 1 further includes:
an attenuator being provided in a preceding stage of the amplifier and attenuating a level of a signal to be inputted into the amplifier,
in the first state of the switching means, the signal to be inputted into the amplifier passing through the attenuator and then being inputted into the amplifier, and
in the second state of the switching means, the signal to be inputted into the amplifier which signal does not pass through the amplifier being directly inputted into the amplifier.

4. The signal distribution device as set forth in claim 1, wherein:
the amplifier includes a first amplifier and a second amplifier which have gains different from each other;
in the first state of the switching means, the signal to be inputted into the distributor passes through the first amplifier and then is inputted into the distributor; and
in the second state of the switching means, a signal to be inputted into the distributor passes through the second amplifier and then is inputted into the distributor.

5. The signal distribution device as set forth in claim 1, wherein:
the amplifier is a variable amplifier whose gain is variable;
the voltage comparison control means controls a gain of the amplifier by applying a gain control voltage varying, according to a voltage value, the gain of the amplifier to a predetermined terminal of the amplifier;
in the first state of the switching means, the voltage comparison control means and the predetermined terminal of the amplifier are electrically connected; and
in the second state of the switching means, the voltage comparison control means and the predetermined terminal of the amplifier are not electrically connected.

6. The signal distribution device as set forth in claim 5, wherein:
the amplifier includes a transistor; and
in the first state of the switching means, the voltage comparison control means applies the gain control voltage to a base of the transistor via the predetermined terminal of the amplifier so as to control the gain of the amplifier.

7. The signal distribution device as set forth in claim 5, wherein:
the amplifier includes a transistor; and
in the first state of the switching means, the voltage comparison control means applies the gain control voltage to an emitter of the transistor via the predetermined terminal of the amplifier so as to control the gain of the amplifier.

8. The signal distribution device as set forth in claim 5, wherein:
the amplifier includes a transistor and a feedback circuit that inputs a part of an output from a collector of the transistor into a base of the transistor; and
in the first state of the switching means, the voltage comparison control means varies an impedance of the feedback circuit by applying the gain control voltage to the feedback circuit via the predetermined terminal of the amplifier, so as to control the gain of the amplifier by variation in the impedance.

9. The signal distribution device as set forth in claim 5, wherein:
the amplifier includes a transistor and one or both of a condenser and a variable capacitor diode that are provided between an emitter of the transistor and a ground plane of the transistor; and
in the first state of the switching means, the voltage comparison control means varies a capacitance of one or both of the condenser and the variable capacitor diode by applying the gain control voltage to one or both of the condenser and the variable capacitor diode via the predetermined terminal of the amplifier, so as to control the gain of the amplifier by variation in the capacitance.

10. The signal distribution device as set forth in claim 1, wherein:
the voltage comparison control means controls switching between the first state and the second state of the switching means, based on a comparison result of comparing the voltage value of the control voltage inputted into the voltage comparison control means and a predetermined threshold value.

11. The signal distribution device as set forth in claim 1, wherein:
the voltage comparison control means stores in advance information for controlling switching of the switching means according to a frequency band of a signal inputted into the signal distribution device.

12. The signal distribution device as set forth in claim 1, wherein:
the voltage comparison control means performs switching control of the switching means once every time a frequency band of a signal inputted into the signal distribution device varies.

13. The signal distribution device as set forth in claim 1, wherein:
a control voltage to be inputted into the voltage comparison control means is outputted from at least one of the plurality of circuits.

14. A signal distribution device including a distributor that outputs to distribute a signal inputted into the distributor into a plurality of circuits, the signal distribution device comprising:
an amplifier amplifying a level of a signal to be inputted into the distributor;
a variable attenuator attenuating a level of a signal to be inputted into the amplifier and having a variable attenuation amount; and
voltage comparison control means controlling the attenuation amount of the variable attenuator according to a voltage value of a control voltage inputted into the voltage comparison control means,
the voltage value of the control voltage inputted into the voltage comparison control means being a register expressing a binary ten-digit value as a value in a decimal system which binary ten-digit value is determined according to a level of the voltage value, and
the voltage comparison control means controlling variation in the attenuation amount of the attenuator based on a comparison result of comparing the register of the voltage value of the control voltage inputted into the voltage comparison control means and a predetermined threshold value of the register.

15. The signal distribution device as set forth in claim 14, wherein:
the voltage comparison control means stores in advance information for controlling the attenuation amount of the variable attenuator according to a frequency band of a signal inputted into the signal distribution device.

16. The signal distribution device as set forth in claim 14, wherein:
the voltage comparison control means performs control of the attenuation amount of the variable attenuator once every time a frequency band of a signal inputted into the signal distribution device varies.

17. The signal distribution device as set forth in claim 14, wherein:
a control voltage to be inputted into the voltage comparison control means is outputted from at least one of the plurality of circuits.

18. A signal distribution device including a distributor that outputs to distribute a signal inputted into the distributor into a plurality of circuits, the signal distribution device comprising:
an amplifier amplifying a level of a signal to be inputted into the distributor;
a variable attenuator attenuating a level of a signal to be inputted into the amplifier and having a variable attenuation amount;
error transmission means transmitting an error flag in case where an error occurs; and
error flag comparison control means, into which the error flag outputted from the error transmission means is inputted, controlling the attenuation amount of the variable attenuator according to a number of times for which the error flag is inputted.

19. The signal distribution device as set forth in claim 18, wherein:
the error flag comparison control means stores in advance information for controlling the attenuation amount of the variable attenuator according to a frequency band of a signal inputted into the signal distribution device.

20. The signal distribution device as set forth in claim 18, wherein:
an error flag to be inputted into the error flag comparison control means is outputted from at least one of the plurality of circuits.

21. The signal distribution device as set forth in claim 18, wherein:
the error flag comparison control means performs control of the attenuation amount of the variable attenuator once every time a frequency band of a signal inputted into the signal distribution device varies.

22. A receiver device provided in an apparatus capable of concurrently receiving a plurality of signals whose frequencies are different, the receiver device comprising:
a signal distribution device including a distributor that outputs to distribute a signal inputted into the distributor into a plurality of circuits,
the signal distribution device comprising:
an amplifier amplifying a level of a signal to be inputted into the distributor;
switching means switching between a first state and a second state, the level of the signal inputted into the distributor in the first state being a different value from a value of the level of the signal inputted into the distributor in the second state; and
voltage comparison control means controlling switching by the switching means according to a voltage value of a control voltage inputted into the voltage comparison control means,
the plurality of circuits being a plurality of receiver circuits that are connected to output terminals of the distributor of the signal distribution device, respectively, and capable of concurrently receiving signals whose frequency bands are different from each other.

23. The receiver device as set forth in claim 22, wherein:
each of the plurality of receiver circuits includes:
a demodulator demodulating a signal inputted; and
a variable gain amplifier, that is provided in a subsequent stage of the distributor and a preceding stage of the demodulator, amplifying the signal inputted and varying a gain according to a power consumption of the variable gain amplifier,
the demodulator varies the gain of the variable gain amplifier according to a level of the signal to be demodulated, by providing the control voltage to the variable gain amplifier, and also outputs the control voltage to the voltage comparison control means of the signal distribution control means.

24. The receiver device as set forth in claim 23, wherein:
the variable gain amplifier amplifies one or both of a level of a radio frequency signal and a level of an intermediate frequency signal.

25. A receiver device provided in an apparatus capable of concurrently receiving a plurality of signals whose frequencies are different, the receiver device comprising:
a signal distribution device including a distributor that outputs to distribute a signal inputted into the distributor a plurality of circuits,
the signal distribution device including:
an amplifier amplifying a level of a signal to be inputted into the distributor;
a variable attenuator attenuating a level of a signal to be inputted into the amplifier and having a variable attenuation amount; and
voltage comparison control means controlling the attenuation amount of the variable attenuator according to a voltage value of a control voltage inputted into the voltage comparison control means,
the voltage value of the control voltage inputted into the voltage comparison control means being a register expressing a binary ten-digit value as a value in a decimal system which binary ten-digit value is determined according to a level of the voltage value,
the voltage comparison control means controlling variation in the attenuation amount of the attenuator based on a comparison result of comparing the register of the voltage value of the control voltage inputted into the voltage comparison control means and a predetermined threshold value of the register,
the plurality of circuits being a plurality of receiver circuits that are connected to output terminals of the distributor of the signal distribution device, respectively, and capable of concurrently receiving signals whose frequency bands are different from each other.
